(19) United States
(12) Patent Application Publication
(10) Pub. No.: US 2020/0074432 A1
(43) Pub. Date: Mar. 5, 2020

(54) DEEP LEARNING-BASED ACTIONABLE DIGITAL RECEIPTS FOR CASHIER-LESS CHECKOUT

(71) Applicant: STANDARD COGNITION, CORP, San Francisco, CA (US)

(72) Inventors: DAVID VALDMAN, SAN FRANCISCO, CA (US); JEAN-CHRISTOPHE SCHMITZ, TOKYO (JP); JUAN C. LASHERAS, SAN FRANCISCO, CA (US)

(73) Assignee: STANDARD COGNITION, CORP, San Francisco, CA (US)

(21) Appl. No.: 16/559,415

(22) Filed: Sep. 3, 2019

Related U.S. Application Data
(60) Provisional application No. 62/726,070, filed on Aug. 31, 2018.

(51) Int. Cl. G06Q 20/18; G06N 3/08; G06Q 10/08; G06Q 20/04

(52) U.S. Cl. CPC G06Q 20/18; G06Q 20/0453; G06Q 10/087; G06N 3/08

(57) ABSTRACT

Systems and techniques are provided for automated shopping. The system processes sequences of sensor data to identify inventory events including item identifier and a classification confidence score. The system includes logic to generate and transmit digital receipts to devices linked to subjects in response to check-out events. The digital receipts include list of items based on the items in a log of items for the particular subject. The digital receipts can include links to graphical constructs for display on the device prompting input to request changes in the list of items. The system includes logic to process refund requests in response to messages from the device for the particular subject.

### PRIORITY APPLICATION

This application claims the benefit of U.S. Provisional Patent Application No. 62/726,070 (Attorney Docket No. STCG 1010-1) filed 31 Aug. 2018, which application is incorporated herein by reference.

### BACKGROUND

### Field

The present invention relates to systems that track inventory items in an area of real space.

### Description of Related Art

Providing a cashier-less shopping experience to customers can present many technical challenges. The customers can walk into the shopping store, move through the aisles, pick items that they need to buy, and move out of the store. An important element of cashier-less shopping experience is to correctly determine the items a shopper has taken from the store and then generate a digital receipt for the customer. This becomes more challenging when a system does not track customers using their biometric information. Another technical challenge is to allow the customers to contest the items or their quantities for which the system has charged them. In existing systems, customers either need to contact the shopping store via phone, email or physically go to the shopping store to request refunds or corrections to their receipts. The shopping stores management then reviews the contests received from the customers and corrects any errors in the receipts.

It is desirable to provide a system that can more effectively and automatically generate digital receipts for customers and process refund requests without requiring customers to contact the shopping store via phone, email or requiring them to physically go to the shopping store.

### SUMMARY

A system and method for operating a system are provided for automated shopping. In an automated shopping environment, in which a digital receipt is delivered to a device associated with a shopper, a technology is provided that supports challenging and correcting items identified in the digital receipt. In one aspect, the digital receipt is presented in a graphic user interface including widgets that prompt challenges to items listed in the receipt. Upon detection of user input engaging the widget, a validation procedure is executed automatically. Validation procedure includes evaluation of the sensor data used in the automated shopping environment, and evaluation of confidence scores associated with evaluating the sensor data. In addition, the validation procedure can include efficient techniques for retrieving the sensor data associated with particular events suitable for use in further review.

The system receives a sequences of sensor data of an area of real space. The sensor data can be sent by a plurality of sensors with overlapping fields of view. The system includes a processor or processors. The processor or processors can include logic to process the sequences of sensor data to identify inventory events in the area of real space linked to individual subjects. The system maintains inventory events as logs of inventory events. The inventory events can include an item identifier and a classification confidence score for the item. The processing system stores sensor data from the sequences of sensor data from which the inventory events are identified. The system includes logic to maintain logs of items for individual subjects. The system generates a digital receipt and transmits the digital receipt to a device associated with a particular subject in response to a check-out event for a particular subject. The digital receipt includes list of items based on the items in the log of items for the particular subject with links to graphical constructs for display on the device prompting input to request changes in the list of items. The system includes logic to receive messages from the device for the particular subject requesting a change in the list of items. In response to messages from the device requesting the change, the system accesses an entry in the log of inventory events for the particular subject corresponding to the requested change. The system compares the classification confidence score in entry with a confidence threshold. In the event the confidence score is lower than the threshold, the system accepts the change and updates the digital receipt. In the event the confidence score is higher than the threshold, the system identifies the inventory event corresponding to the change and retrieves a set of sensor data from the stored sequences of sensor data for corroboration of the identified inventory event.

In one embodiment, the system includes logic to send the set of sensor data or a link to the set of sensor data to a monitor device for review by human operator. In one embodiment, the system includes logic to send a message to the device acknowledging the requested change. In one embodiment, the system includes logic operable in the event the confidence score is lower than the threshold, to send a message to the device accepting the requested change. In one embodiment, the system includes logic operable in the event the confidence score is higher than the threshold, to send a message to the device indicating requested change is under review.

In one embodiment, the system includes logic to process the sensor data to track individual subjects in the area of real space, and to link individual subjects to inventory events. The system includes logic to establish a communication link to devices associated with the individual subjects, on which to receive said messages from particular subjects and to send messages to particular subjects.

In one embodiment, the system includes logic to process the sensor data to track locations of individual subjects in the area of real space, and signal said check-out event for a particular subject if the location of the particular subject is tracked to a particular region of the area of real space.

In one embodiment, the system includes logic to establish a communication link to devices associated with the individual subjects, on which to receive messages from particular subjects interpreted as said check-out event. The sequences of sensor data comprise a plurality of sequences of images having overlapping fields of view. The log of items includes puts and take of inventory items.

Methods and computer program products which can be executed by computer systems are also described herein.

Functions are described herein, including but not limited to identifying and linking particular inventory items to individual subjects or shoppers, generating digital receipts for individual subjects in response to check-out events for the particular subject, and receiving and processing refund requests from subjects present complex problems of computing engineering, relating for example to the type of image data to be processed, what processing of the image data to perform, and how to determine actions from the image data with high reliability.

Other aspects and advantages of the present invention can be seen on review of the drawings, the detailed description and the claims, which follow.

### BRIEF DESCRIPTION OF THE DRAWINGS

FIG. 1 illustrates an architectural level schematic of a system in which a digital receipts processing engine and a subject tracking engine generate actionable digital receipts for subjects.

FIG. 2A is a side view of an aisle in a shopping store illustrating a subject with a mobile computing device, inventory display structures and a camera arrangement.

FIG. 2B is a top view of the aisle of FIG. 2A in a shopping store illustrating the subject with the mobile computing device and the camera arrangement.

FIG. 3 is a perspective view of an inventory display structure in the aisle in FIGS. 2A and 2B, illustrating a subject taking an item from a shelf in the inventory display structure.

FIG. 4 shows an example data structure for storing joints information of subjects.

FIG. 5 is an example data structure for storing a subject's information including the associated joints.

FIG. 6 is an example high-level architecture of an image processing pipeline comprising first image processors, second image processors, and third image processors.

FIG. 7 shows an example of a log of items data structure which can be used to store shopping cart of a subject.

FIG. 8 is a high-level architecture of a system to generate actionable digital receipts and process refund requests received from customers.

FIGS. 9A to 9H (collectively FIG. 9) present examples of user interfaces for displaying actionable digital receipts in a first embodiment.

FIGS. 10A to 10D (collectively FIG. 10) present examples of user interfaces for displaying actionable digital receipts in a second embodiment.

FIG. 11 is a flowchart showing server-side process steps for generating actionable digital receipts.

FIG. 12 is a flowchart showing process steps for requesting refund using an actionable digital receipt displayed on a computing device.

FIG. 13 is a flowchart showing server-side process steps for processing refund request.

FIG. 14 is a camera and computer hardware arrangement configured for hosting the digital receipts processing engine of FIG. 1.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not intended to be limited to the embodiments shown but is to be accorded the widest scope consistent with the principles and features disclosed herein.

### System Overview

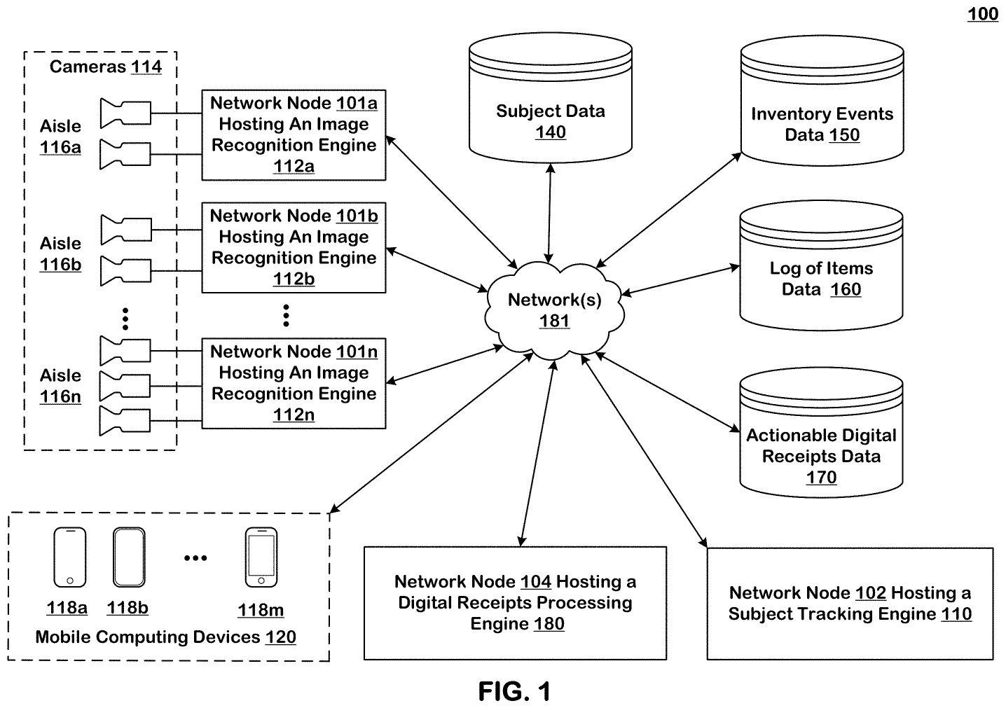

A system and various implementations of the subject technology is described with reference to FIGS. 1-14. The system and processes are described with reference to FIG. 1, an architectural level schematic of a system in accordance with an implementation. Because FIG. 1 is an architectural diagram, certain details are omitted to improve the clarity of the description.

The discussion of FIG. 1 is organized as follows. First, the elements of the system are described, followed by their interconnections. Then, the use of the elements in the system is described in greater detail. In examples described herein, cameras are used as sensors producing image frames which output color images in for example an RGB color space. In all of the disclosed embodiments, other types of sensors or combinations of sensors of various types can be used to produce image frames usable with or in place of the cameras, including image sensors working in other color spaces, infrared image sensors, UV image sensors, ultrasound image sensors, LIDAR based sensors, radar based sensors and so on.

FIG. 1 provides a block diagram level illustration of a system 100. The system 100 includes cameras 114, network nodes hosting image recognition engines 112a, 112b, and up to 112n, mobile computing devices 118a, 118b, 118m (collectively referred as mobile computing devices 120), a digital receipts processing engine 180 deployed in a network node 104 (or nodes) on the network, a network node 102 hosting a subject tracking engine 110, a subject database 140, an inventory events database 150, a log of items or shopping carts database 160, a digital receipts (also referred to as actionable digital receipts) database 170, and a communication network or networks 181. The network nodes can host only one image recognition engine, or several image recognition engines. The system can also include a subject (or user) accounts database and other supporting data.

As used herein, a network node is an addressable hardware device or virtual device that is attached to a network, and is capable of sending, receiving, or forwarding information over a communications channel to or from other network nodes. Examples of electronic devices which can be deployed as hardware network nodes include all varieties of computers, workstations, laptop computers, handheld computers, and smartphones. Network nodes can be implemented in a cloud-based server system. More than one virtual device configured as a network node can be implemented using a single physical device.

For the sake of clarity, only three network nodes hosting image recognition engines are shown in the system 100. However, any number of network nodes hosting image recognition engines can be connected to the subject tracking engine 110 through the network(s) 181. Similarly, the digital receipts processing engine, and the subject tracking engine and other processing engines described herein can execute using more than one network node in a distributed architecture.

The interconnection of the elements of system 100 will now be described. Network(s) 181 couples the network nodes 101a, 101b, and 101n, respectively, hosting image recognition engines 112a, 112b, and up to 112n, the network node 104 hosting the digital receipts processing engine 180, the network node 102 hosting the subject tracking engine 110, the subject database 140, the inventory events database 150, the log of items database 160, and the actionable digital receipts database 170. Cameras 114 are connected to the subject tracking engine 110 through network nodes hosting image recognition engines 112a, 112b, and up to 112n. In one embodiment, the cameras 114 are installed in a shopping store such that sets of cameras 114 (two or more) with overlapping fields of view are positioned over each aisle to capture image frames of real space in the store. In FIG. 1, two cameras are arranged over aisle 116a, two cameras are arranged over aisle 116b, and three cameras are arranged over aisle 116n. The cameras 114 are installed over aisles with overlapping fields of view. In such an embodiment, the cameras are configured with the goal that customers moving in the aisles of the shopping store are present in the field of view of two or more cameras at any moment in time.

Cameras 114 can be synchronized in time with each other, so that image frames are captured at the same time, or close in time, and at the same image capture rate. The cameras 114 can send respective continuous streams of image frames at a predetermined rate to network nodes hosting image recognition engines 112a-112n. Image frames captured in all the cameras covering an area of real space at the same time, or close in time, are synchronized in the sense that the synchronized image frames can be identified in the processing engines as representing different views of subjects having fixed positions in the real space. For example, in one embodiment, the cameras send image frames at the rates of 30 frames per second (fps) to respective network nodes hosting image recognition engines 112a-112n. Each frame has a timestamp, identity of the camera (abbreviated as “camera_id”), and a frame identity (abbreviated as “frame_id”) along with the image data. Other embodiments of the technology disclosed can use different types of sensors such as image sensors, LIDAR based sensors, etc., in place of cameras to generate this data. In one embodiment, sensors can be used in addition to the cameras 114. Multiple sensors can be synchronized in time with each other, so that frames are captured by the sensors at the same time, or close in time, and at the same frame capture rate.

Cameras installed over an aisle are connected to respective image recognition engines. For example, in FIG. 1, the two cameras installed over the aisle 116a are connected to the network node 101a hosting an image recognition engine 112a. Likewise, the two cameras installed over aisle 116b are connected to the network node 101b hosting an image recognition engine 112b. Each image recognition engine 112a-112n hosted in a network node or nodes 101a-101n, separately processes the image frames received from one camera each in the illustrated example.

In one embodiment, each image recognition engine 112a, 112b, and up to 112n is implemented as a deep learning algorithm such as a convolutional neural network (abbreviated CNN). In such an embodiment, the CNN is trained using training database. In an embodiment described herein, image recognition of subjects in the real space is based on identifying and grouping joints recognizable in the image frames, where the groups of joints can be attributed to an individual subject. For this joints-based analysis, the training database has a large collection of images for each of the different types of joints for subjects. In the example embodiment of a shopping store, the subjects are the customers moving in the aisles between the shelves. In an example embodiment, during training of the CNN, the system 100 is referred to as a “training system.” After training the CNN using the training database, the CNN is switched to production mode to process images of customers in the shopping store in real time.

In an example embodiment, during production, the system 100 is referred to as a runtime system (also referred to as an inference system). The CNN in each image recognition engine produces arrays of joints data structures for image frames in its respective stream of image frames. In an embodiment as described herein, an array of joints data structures is produced for each processed image, so that each image recognition engine 112a-112n produces an output stream of arrays of joints data structures. These arrays of joints data structures from cameras having overlapping fields of view are further processed to form groups of joints, and to identify such groups of joints as subjects. The subjects can be identified and tracked by the system using a subject identifier such as “subject id” during their presence in the area of real space.

The subject tracking engine 110, hosted on the network node 102 receives, in this example, continuous streams of arrays of joints data structures for the subjects from image recognition engines 112a-112n. The subject tracking engine 110 processes the arrays of joints data structures and translates the coordinates of the elements in the arrays of joints data structures corresponding to image frames in different sequences into candidate joints having coordinates in the real space. For each set of synchronized image frames, the combination of candidate joints identified throughout the real space can be considered, for the purposes of analogy, to be like a galaxy of candidate joints. For each succeeding point in time, movement of the candidate joints is recorded so that the galaxy changes over time. The output of the subject tracking engine 110 identifies subjects in the area of real space at a moment in time.

The subject tracking engine 110 uses logic to identify groups or sets of candidate joints having coordinates in real space as subjects in the real space. For the purposes of analogy, each set of candidate points is like a constellation of candidate joints at each point in time. The constellations of candidate joints can move over time. A time sequence analysis of the output of the subject tracking engine 110 over a period of time identifies movements of subjects in the area of real space.

In an example embodiment, the logic to identify sets of candidate joints comprises heuristic functions based on physical relationships amongst joints of subjects in real space. These heuristic functions are used to identify sets of candidate joints as subjects. The sets of candidate joints comprise individual candidate joints that have relationships according to the heuristic parameters with other individual candidate joints and subsets of candidate joints in a given set that has been identified, or can be identified, as an individual subject.

In the example of a shopping store the customers (also referred to as subjects above) move in the aisles and in open spaces. The customers take items from inventory locations on shelves in inventory display structures. In one example of inventory display structures, shelves are arranged at different levels (or heights) from the floor and inventory items are stocked on the shelves. The shelves can be fixed to a wall or placed as freestanding shelves forming aisles in the shopping store. Other examples of inventory display structures include, pegboard shelves, magazine shelves, lazy susan shelves, warehouse shelves, and refrigerated shelving units. The inventory items can also be stocked in other types of inventory display structures such as stacking wire baskets, dump bins, etc. The customers can also put items back on the same shelves from where they were taken or on another shelf.

The technology disclosed uses the sequences of image frames produced by cameras in the plurality of cameras to identify gestures by detected subjects in the area of real space over a period of time and produce inventory events including data representing identified gestures. The system includes logic to store the inventory events as entries in the inventory events database 150. The inventory event includes a subject identifier identifying a detected subject, a gesture type (e.g., a put or a take) of the identified gesture by the detected subject, an item identifier identifying an inventory item linked to the gesture by the detected subject, a location of the gesture represented by positions in three dimensions of the area of real space and a timestamp for the gesture. The inventory events are stored as entries in the logs of events for subjects. A log of event can include entries for events linked to individual subject. The inventory event data is stored as entries in the inventory events database 150.

In one embodiment, the image analysis is anonymous, i.e., a unique identifier assigned to a subject created through joints analysis does not identify personal identification details of any specific subject in the real space. For example, when a customer enters a shopping store, the system identifies the customer using joints analysis as described above and is assigned a “subject id”. This identifier is, however, not linked to real world identity of the subject such as user account, name, driver's license, email addresses, mailing addresses, credit card numbers, bank account numbers, driver's license number, etc. or to identifying biometric identification such as finger prints, facial recognition, hand geometry, retina scan, iris scan, voice recognition, etc. Therefore, the identified subject is anonymous. Details of an example technology for subject identification and tracking are presented in U.S. Pat. No. 10,055,853, issued 21 Aug. 2018, titled, “Subject Identification and Tracking Using Image Recognition Engine” which is incorporated herein by reference as if fully set forth herein. The data stored in the subject database 140, the inventory events database 150, the log of items or shopping carts database 160, and the actionable digital receipts database 170 does not include any personal identification information. The operations of the digital receipts processing engine 180 and the subject tracking engine 110 do not use any personal identification including biometric information associated with the subjects.

### Matching Engine for Check-in

The system can include a matching engine that includes logic to match the identified subjects with their respective user accounts by identifying locations of mobile devices (carried by the identified subjects) that are executing client applications in the area of real space. The matching of identified subjects with their respective user accounts is also referred to as “check-in”. In one embodiment, the matching engine uses multiple techniques, independently or in combination, to match the identified subjects with the user accounts. The system can be implemented without maintaining biometric identifying information about users, so that biometric information about account holders is not exposed to security and privacy concerns raised by distribution of such information.

In one embodiment, a customer logs in to the system using a client application executing on a personal mobile computing device upon entering the shopping store, identifying an authentic user account to be associated with the client application on the mobile device. The system then sends a “semaphore” image selected from the set of unassigned semaphore images in an image database (not shown in FIG. 1) to the client application executing on the mobile device. The semaphore image is unique to the client application in the shopping store as the same image is not freed for use with another client application in the store until the system has matched the user account to an identified subject. After that matching, the semaphore image becomes available for use again. The client application causes the mobile device to display the semaphore image, which display of the semaphore image is a signal emitted by the mobile device to be detected by the system. The matching engine uses the image recognition engines 112a-n or a separate image recognition engine (not shown in FIG. 1) to recognize the semaphore image and determine the location of the mobile computing device displaying the semaphore in the shopping store. The matching engine matches the location of the mobile computing device to a location of an identified subject. The matching engine then links the identified subject (stored in the subject database 140) to the user account (stored in the user account database) linked to the client application for the duration in which the subject is present in the shopping store. No biometric identifying information is used for matching the identified subject with the user account, and none is stored in support of this process. That is, there is no information in the sequences of images used to compare with stored biometric information for the purposes of matching the identified subjects with user accounts in support of this process.

In other embodiments, the matching engine uses other signals in the alternative or in combination from the mobile computing devices 120 to link the identified subjects to user accounts. Examples of such signals include a service location signal identifying the position of the mobile computing device in the area of the real space, speed and orientation of the mobile computing device obtained from the accelerometer and compass of the mobile computing device, etc.

In some embodiments, though embodiments are provided that do not maintain any biometric information about account holders, the system can use biometric information to assist matching a not-yet-linked identified subject to a user account. For example, in one embodiment, the system stores “hair color” of the customer in his or her user account record. During the matching process, the system might use for example hair color of subjects as an additional input to disambiguate and match the subject to a user account. If the user has red colored hair and there is only one subject with red colored hair in the area of real space or in close proximity of the mobile computing device, then the system might select the subject with red hair color to match the user account. Details of an example technology for matching subjects and their user accounts are presented in U.S. patent application Ser. No. 16/255,573, filed 23 Jan. 2019, titled, “Systems and Methods to Check-in Shoppers in a Cashier-less Store” which is incorporated herein by reference as if fully set forth herein.

The actual communication path to the network nodes 104 hosting the digital receipts processing engine 180 and the network node 102 hosting the subject tracking engine 110 through the network 181 can be point-to-point over public and/or private networks. The communications can occur over a variety of networks 181, e.g., private networks, VPN, MPLS circuit, or Internet, and can use appropriate application programming interfaces (APIs) and data interchange formats, e.g., Representational State Transfer (REST), JavaScript™ Object Notation (JSON), Extensible Markup Language (XML), Simple Object Access Protocol (SOAP), Java™ Message Service (JMS), and/or Java Platform Module System. All of the communications can be encrypted. The communication is generally over a network such as a LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi, and WiMAX. Additionally, a variety of authorization and authentication techniques, such as username/password, Open Authorization (OAuth), Kerberos, SecureID, digital certificates and more, can be used to secure the communications.

The technology disclosed herein can be implemented in the context of any computer-implemented system including a database system, a multi-tenant environment, or a relational database implementation like an Oracle™ compatible database implementation, an IBM DB2 Enterprise Server™ compatible relational database implementation, a MySQL™ or PostgreSQL™ compatible relational database implementation or a Microsoft SQL Server™ compatible relational database implementation or a NoSQL™ non-relational database implementation such as a Vampire™ compatible non-relational database implementation, an Apache Cassandra™ compatible non-relational database implementation, a BigTable™ compatible non-relational database implementation or an HBase™ or DynamoDB™ compatible non-relational database implementation. In addition, the technology disclosed can be implemented using different programming models like MapReduce™, bulk synchronous programming, MPI primitives, etc. or different scalable batch and stream management systems like Apache Storm™, Apache Spark™, Apache Kafka™, Apache Flink™, Truviso™, Amazon Elasticsearch Service™, Amazon Web Services™ (AWS), IBM Info-Sphere™, Borealis™, and Yahoo! S4™.

### Camera Arrangement

The cameras 114 are arranged to track multi-joint subjects (or entities) in a three-dimensional (abbreviated as 3D) real space. In the example embodiment of the shopping store, the real space can include the area of the shopping store where items for sale are stacked in shelves. A point in the real space can be represented by an (x, y, z) coordinate system. Each point in the area of real space for which the system is deployed is covered by the fields of view of two or more cameras 114.

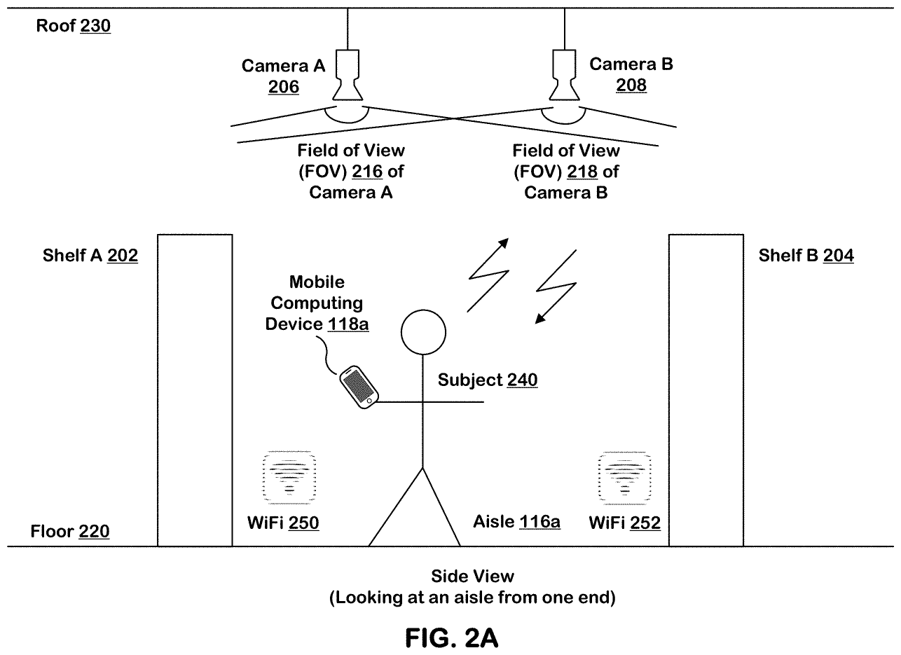

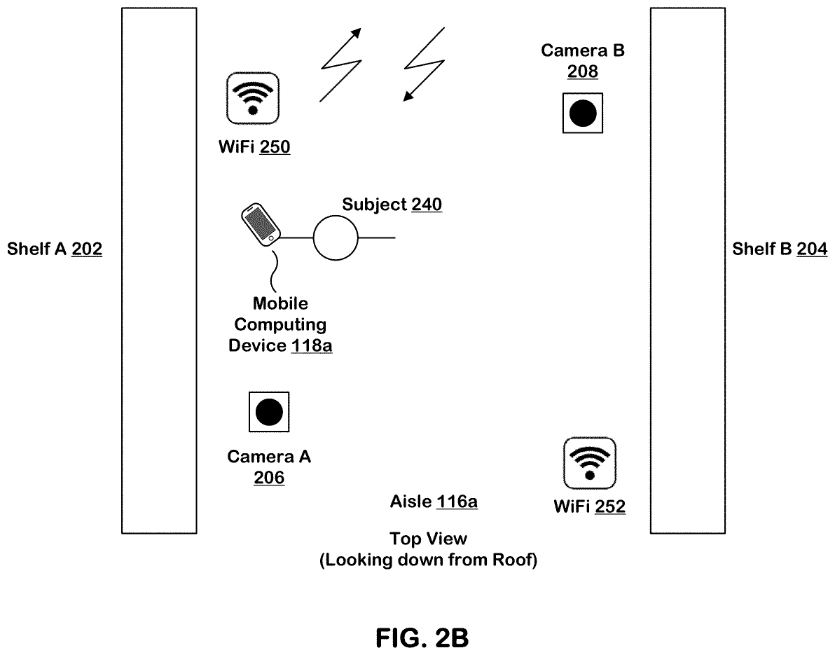

In a shopping store, the shelves and other inventory display structures can be arranged in a variety of manners, such as along the walls of the shopping store, or in rows forming aisles or a combination of the two arrangements. FIG. 2A shows an arrangement of shelves, forming an aisle 116a, viewed from one end of the aisle 116a. Two cameras, camera A 206 and camera B 208 are positioned over the aisle 116a at a predetermined distance from a roof 230 and a floor 220 of the shopping store above the inventory display structures, such as shelves. The cameras 114 comprise cameras disposed over and having fields of view encompassing respective parts of the inventory display structures and floor area in the real space. The coordinates in real space of members of a set of candidate joints, identified as a subject, identify locations of the subject in the floor area. In FIG. 2A, a subject 240 is holding the mobile computing device 118a and standing on the floor 220 in the aisle 116a. The mobile computing device can send and receive signals through the wireless network(s) 181. In one example, the mobile computing devices 120 communicate through a wireless network using for example a Wi-Fi protocol, or other wireless protocols like Bluetooth, ultra-wideband, and ZigBee, through wireless access points (WAP) 250 and 252.

In the example embodiment of the shopping store, the real space can include all of the floor 220 in the shopping store from which inventory can be accessed. Cameras 114 are placed and oriented such that areas of the floor 220 and shelves can be seen by at least two cameras. The cameras 114 also cover at least part of the shelves 202 and 204 and floor space in front of the shelves 202 and 204. Camera angles are selected to have both steep perspective, straight down, and angled perspectives that give more full body images of the customers. In one example embodiment, the cameras 114 are configured at an eight (8) foot height or higher throughout the shopping store.

In FIG. 2A, the cameras 206 and 208 have overlapping fields of view, covering the space between a shelf A 202 and a shelf B 204 with overlapping fields of view 216 and 218, respectively. A location in the real space is represented as a (x, y, z) point of the real space coordinate system. “x” and “y” represent positions on a two-dimensional (2D) plane which can be the floor 220 of the shopping store. The value “z” is the height of the point above the 2D plane at floor 220 in one configuration.

FIG. 2B illustrates the aisle 116a viewed from the top of FIG. 2, further showing an example arrangement of the positions of cameras 206 and 208 over the aisle 116a. The cameras 206 and 208 are positioned closer to opposite ends of the aisle 116a. The camera A 206 is positioned at a predetermined distance from the shelf A 202 and the camera B 208 is positioned at a predetermined distance from the shelf B 204. In another embodiment, in which more than two cameras are positioned over an aisle, the cameras are positioned at equal distances from each other. In such an embodiment, two cameras are positioned close to the opposite ends and a third camera is positioned in the middle of the aisle. It is understood that a number of different camera arrangements are possible.

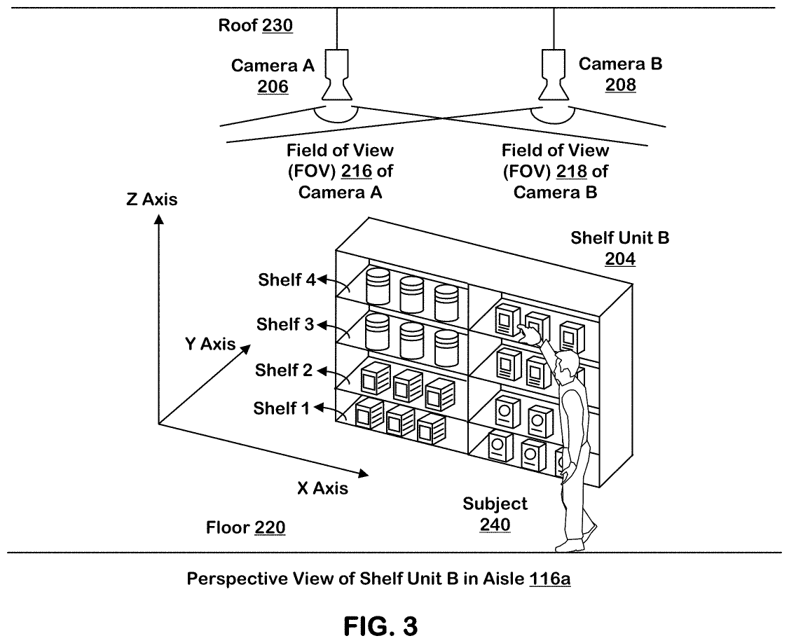

In FIG. 3, a subject 240 is standing by an inventory display structure shelf unit B 204, with one hand positioned close to a shelf (not visible) in the shelf unit B 204. FIG. 3 is a perspective view of the shelf unit B 204 with four shelves, shelf 1, shelf 2, shelf 3, and shelf 4 positioned at different levels from the floor. The inventory items are stocked on the shelves.

### Three Dimensional Scene Generation

A location in the real space is represented as a (x, y, z) point of the real space coordinate system. “x” and “y” represent positions on a two-dimensional (2D) plane which can be the floor 220 of the shopping store. The value “z” is the height of the point above the 2D plane at floor 220 in one configuration. The system combines 2D image frames from two or cameras to generate the three dimensional positions of joints and inventory events (indicating puts and takes of items from shelves) in the area of real space. This section presents a description of the process to generate 3D coordinates of joints and inventory events. The process is an example of 3D scene generation.

Before using the system 100 in training or inference mode to track the inventory items, two types of camera calibrations: internal and external, are performed. In internal calibration, the internal parameters of the cameras 114 are calibrated. Examples of internal camera parameters include focal length, principal point, skew, fisheye coefficients, etc. A variety of techniques for internal camera calibration can be used. One such technique is presented by Zhang in “A flexible new technique for camera calibration” published in IEEE Transactions on Pattern Analysis and Machine Intelligence, Volume 22, No. 11, November 2000.

In external calibration, the external camera parameters are calibrated in order to generate mapping parameters for translating the 2D image data into 3D coordinates in real space. In one embodiment, one multi-joint subject, such as a person, is introduced into the real space. The multi-joint subject moves through the real space on a path that passes through the field of view of each of the cameras 114. At any given point in the real space, the multi-joint subject is present in the fields of view of at least two cameras forming a 3D scene. The two cameras, however, have a different view of the same 3D scene in their respective two-dimensional (2D) image planes. A feature in the 3D scene such as a left-wrist of the multi-joint subject is viewed by two cameras at different positions in their respective 2D image planes.

A point correspondence is established between every pair of cameras with overlapping fields of view for a given scene. Since each camera has a different view of the same 3D scene, a point correspondence is two pixel locations (one location from each camera with overlapping field of view) that represent the projection of the same point in the 3D scene. Many point correspondences are identified for each 3D scene using the results of the image recognition engines 112a-112n for the purposes of the external calibration. The image recognition engines identify the position of a joint as (x, y) coordinates, such as row and column numbers, of pixels in the 2D image planes of respective cameras 114. In one embodiment, a joint is one of 19 different types of joints of the multi-joint subject. As the multi-joint subject moves through the fields of view of different cameras, the tracking engine 110 receives (x, y) coordinates of each of the 19 different types of joints of the multi-joint subject used for the calibration from cameras 114 per image.

For example, consider an image from a camera A and an image from a camera B both taken at the same moment in time and with overlapping fields of view. There are pixels in an image from camera A that correspond to pixels in a synchronized image from camera B. Consider that there is a specific point of some object or surface in view of both camera A and camera B and that point is captured in a pixel of both image frames. In external camera calibration, a multitude of such points are identified and referred to as corresponding points. Since there is one multi-joint subject in the field of view of camera A and camera B during calibration, key joints of this multi-joint subject are identified, for example, the center of left wrist. If these key joints are visible in image frames from both camera A and camera B then it is assumed that these represent corresponding points. This process is repeated for many image frames to build up a large collection of corresponding points for all pairs of cameras with overlapping fields of view. In one embodiment, image frames are streamed off of all cameras at a rate of 30 FPS (frames per second) or more and a resolution of 720 pixels in full RGB (red, green, and blue) color. These image frames are in the form of one-dimensional arrays (also referred to as flat arrays).

The large number of image frames collected above for a multi-joint subject are used to determine corresponding points between cameras with overlapping fields of view. Consider two cameras A and B with overlapping field of view. The plane passing through camera centers of cameras A and B and the joint location (also referred to as feature point) in the 3D scene is called the “epipolar plane”. The intersection of the epipolar plane with the 2D image planes of the cameras A and B defines the “epipolar line”. Given these corresponding points, a transformation is determined that can accurately map a corresponding point from camera A to an epipolar line in camera B's field of view that is guaranteed to intersect the corresponding point in the image frame of camera B. Using the image frames collected above for a multi-joint subject, the transformation is generated. It is known in the art that this transformation is non-linear. The general form is furthermore known to require compensation for the radial distortion of each camera's lens, as well as the non-linear coordinate transformation moving to and from the projected space. In external camera calibration, an approximation to the ideal non-linear transformation is determined by solving a non-linear optimization problem. This non-linear optimization function is used by the subject tracking engine 110 to identify the same joints in outputs (arrays of joint data structures) of different image recognition engines 112a-112n, processing image frames of cameras 114 with overlapping fields of view. The results of the internal and external camera calibration are stored in a calibration database.

A variety of techniques for determining the relative positions of the points in image frames of cameras 114 in the real space can be used. For example, Longuet-Higgins published, “A computer algorithm for reconstructing a scene from two projections” in Nature, Volume 293, 10 Sep. 1981. This paper presents computing a three-dimensional structure of a scene from a correlated pair of perspective projections when spatial relationship between the two projections is unknown. Longuet-Higgins paper presents a technique to determine the position of each camera in the real space with respect to other cameras. Additionally, their technique allows triangulation of a multi-joint subject in the real space, identifying the value of the z-coordinate (height from the floor) using image frames from cameras 114 with overlapping fields of view. An arbitrary point in the real space, for example, the end of a shelf unit in one corner of the real space, is designated as a (0, 0, 0) point on the (x, y, z) coordinate system of the real space.

In an embodiment of the technology, the parameters of the external calibration are stored in two data structures. The first data structure stores intrinsic parameters. The intrinsic parameters represent a projective transformation from the 3D coordinates into 2D image coordinates. The first data structure contains intrinsic parameters per camera as shown below. The data values are all numeric floating point numbers. This data structure stores a 3×3 intrinsic matrix, represented as “K” and distortion coefficients. The distortion coefficients include six radial distortion coefficients and two tangential distortion coefficients. Radial distortion occurs when light rays bend more near the edges of a lens than they do at its optical center. Tangential distortion occurs when the lens and the image plane are not parallel. The following data structure shows values for the first camera only. Similar data is stored for all the cameras 114.

{

1: {

K: [[x, x, x], [x, x, x], [x, x, x]],
distortion _coefficients: [x, x, x, x, x, x, x, x]

},

}

The second data structure stores per pair of cameras: a 3×3 fundamental matrix (F), a 3×3 essential matrix (E), a 3×4 projection matrix (P), a 3×3 rotation matrix (R) and a 3×1 translation vector (t). This data is used to convert points in one camera's reference frame to another camera's reference frame. For each pair of cameras, eight homography coefficients are also stored to map the plane of the floor 220 from one camera to another. A fundamental matrix is a relationship between two image frames of the same scene that constrains where the projection of points from the scene can occur in both image frames. Essential matrix is also a relationship between two image frames of the same scene with the condition that the cameras are calibrated. The projection matrix gives a vector space projection from 3D real space to a subspace. The rotation matrix is used to perform a rotation in Euclidean space. Translation vector “t” represents a geometric transformation that moves every point of a figure or a space by the same distance in a given direction. The homography_floor_coefficients are used to combine image frames of features of subjects on the floor 220 viewed by cameras with overlapping fields of views. The second data structure is shown below. Similar data is stored for all pairs of cameras. As indicated previously, the x's represents numeric floating point numbers.

{

1: {

2: {

F: [[x, x, x], [x, x, x], [x, x, x]],
E: [[x, x, x], [x, x, x], [x, x, x]],
P: [[x, x, x, x], [x, x, x, x], [x, x, x, x]],
R: [[x, x, x], [x, x, x], [x, x, x]],
t: [x, x, x],
homography_floor_coefficients: [x, x, x, x, x, x, x, x]

}

},
.......

}

### Two Dimensional and Three Dimensional Maps

An inventory location, such as a shelf, in a shopping store can be identified by a unique identifier (e.g., shelf_id). Similarly, a shopping store can also be identified by a unique identifier (e.g., store_id). The system can include two dimensional (2D) and three dimensional (3D) maps databases which identify inventory locations in the area of real space along the respective coordinates. For example, in a 2D map, the locations in the maps define two dimensional regions on the plane formed perpendicular to the floor 220 i.e., XZ plane as shown in FIG. 3. The map defines an area for inventory locations where inventory items are positioned. A 2D view of shelf 1 in shelf unit B 204 is an area formed by four coordinate positions (x1, z1), (x1, z2), (x2, z2), and (x2, z1) representing the four corners of shelf 1. These coordinate positions define a 2D region in which inventory items are positioned on the shelf 1. Similar 2D areas are defined for all inventory locations in all shelf units (or other inventory display structures) in the shopping store. This information is stored in the maps database 140.

In a 3D map, the locations in the map define three dimensional regions in the 3D real space defined by X, Y, and Z coordinates. The map defines a volume for inventory locations where inventory items are positioned. A 3D view of shelf 1 in shelf unit B 204 is a volume formed by eight coordinate positions (x1, y1, z1), (x1, y1, z2), (x1, y2, z1), (x1, y2, z2), (x2, y1, z1), (x2, y1, z2), (x2, y2, z1), (x2, y2, z2) corresponding to the eight corners of the volume. These coordinates locations define a 3D region in which inventory items are positioned on the shelf 1. Similar 3D regions are defined for inventory locations in all shelf units in the shopping store and stored as a 3D map of the real space (shopping store) in the maps database. The coordinate positions along the three axes can be used to calculate length, depth and height of the inventory locations.

In one embodiment, the map identifies a configuration of units of volume which correlate with portions of inventory locations on the inventory display structures in the area of real space. Each portion is defined by starting and ending positions along the three axes of the real space. Similar configuration of portions of inventory locations can also be generated using a 2D map of inventory locations dividing the front plan of the display structures.

The items in a shopping store are arranged in some embodiments according to a planogram which identifies the inventory locations (such as shelves) on which a particular item is planned to be placed. For example, as shown in an illustration 360 in FIG. 3, a left half portion of shelf 3 and shelf 4 are designated for an item (which is stocked in the form of cans).

The technology disclosed can calculate a “realogram” of the shopping store at any time “t” which is the real time map of locations of inventory items in the area of real space, which can be correlated in addition in some embodiments with inventory locations in the store. A realogram can be used to create a planogram by identifying inventory items and a position in the store, and mapping them to inventory locations. In an embodiment, the system or method can create a data set defining a plurality of cells having coordinates in the area of real space. The system or method can divide the real space into a data set defining a plurality of cells using the length of the cells along the coordinates of the real space as an input parameter. In one embodiment, the cells are represented as two dimensional grids having coordinates in the area of real space. For example, the cells can correlate with 2D grids (e.g. at 1 foot spacing) of front plan of inventory locations in shelf units (also referred to as inventory display structures). Each grid is defined by its starting and ending positions on the coordinates of the two dimensional plane such as x and z coordinates. This information is stored in maps database.

In another embodiment, the cells are represented as three dimensional (3D) grids having coordinates in the area of real space. In one example, the cells can correlate with volume on inventory locations (or portions of inventory locations) in shelf units in the shopping store. In this embodiment, the map of the real space identifies a configuration of units of volume which can correlate with portions of inventory locations on inventory display structures in the area of real space. This information is stored in maps database. The realogram of the shopping store indicates inventory items associated with inventory events matched by their locations to cells at any time t by using timestamps of the inventory events stored in the inventory events database 150.

### Joints Data Structure

The image recognition engines 112a-112n receive the sequences of image frames from cameras 114 and process image frames to generate corresponding arrays of joints data structures. The system includes processing logic that uses the sequences of image frames produced by the plurality of camera to track locations of a plurality of subjects (or customers in the shopping store) in the area of real space. In one embodiment, the image recognition engines 112a-112n identify one of the 19 possible joints of a subject at each element of the image, usable to identify subjects in the area who may be taking and putting inventory items. The possible joints can be grouped in two categories: foot joints and non-foot joints. The 19^{th} type of joint classification is for all non-joint features of the subject (i.e. elements of the image not classified as a joint). In other embodiments, the image recognition engine may be configured to identify the locations of hands specifically. Also, other techniques, such as a user check-in procedure or biometric identification processes, may be deployed for the purposes of identifying the subjects and linking the subjects with detected locations of their hands as they move throughout the store.

Foot Joints:
Ankle joint (left and right)

Non-foot Joints:
Neck
Nose
Eyes (left and right)
Ears (left and right)
Shoulders (left and right)
Elbows (left and right)
Wrists (left and right)
Hip (left and right)
Knees (left and right)

Not a joint

An array of joints data structures for a particular image classifies elements of the particular image by joint type, time of the particular image, and the coordinates of the elements in the particular image. In one embodiment, the image recognition engines 112a-112n are convolutional neural networks (CNN), the joint type is one of the 19 types of joints of the subjects, the time of the particular image is the timestamp of the image generated by the source camera 114 for the particular image, and the coordinates (x, y) identify the position of the element on a 2D image plane.

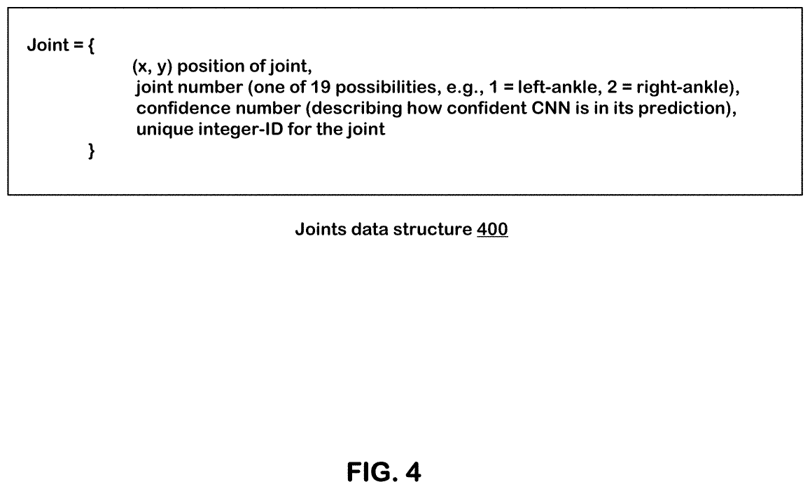

The output of the CNN is a matrix of confidence arrays for each image per camera. The matrix of confidence arrays is transformed into an array of joints data structures. A joints data structure 400 as shown in FIG. 4 is used to store the information of each joint. The joints data structure 400 identifies x and y positions of the element in the particular image in the 2D image space of the camera from which the image is received. A joint number identifies the type of joint identified. For example, in one embodiment, the values range from 1 to 19. A value of 1 indicates that the joint is a left ankle, a value of 2 indicates the joint is a right ankle and so on. The type of joint is selected using the confidence array for that element in the output matrix of CNN. For example, in one embodiment, if the value corresponding to the left-ankle joint is highest in the confidence array for that image element, then the value of the joint number is “1”.

A confidence number indicates the degree of confidence of the CNN in predicting that joint. If the value of confidence number is high, it means the CNN is confident in its prediction. An integer-Id is assigned to the joints data structure to uniquely identify it. Following the above mapping, the output matrix of confidence arrays per image is converted into an array of joints data structures for each image. In one embodiment, the joints analysis includes performing a combination of k-nearest neighbors, mixture of Gaussians, and various image morphology transformations on each input image. The result comprises arrays of joints data structures which can be stored in the form of a bit mask in a ring buffer that maps image numbers to bit masks at each moment in time.

### Subject Tracking Engine

The tracking engine 110 is configured to receive arrays of joints data structures generated by the image recognition engines 112a-112n corresponding to image frames in sequences of image frames from cameras having overlapping fields of view. The arrays of joints data structures per image are sent by image recognition engines 112a-112n to the tracking engine 110 via the network(s) 181. The tracking engine 110 translates the coordinates of the elements in the arrays of joints data structures corresponding to image frames in different sequences into candidate joints having coordinates in the real space. A location in the real space is covered by the field of views of two or more cameras. The tracking engine 110 comprises logic to detect sets of candidate joints having coordinates in real space (constellations of joints) as subjects in the real space. In one embodiment, the tracking engine 110 accumulates arrays of joints data structures from the image recognition engines for all the cameras at a given moment in time and stores this information as a dictionary in a subject database, to be used for identifying a constellation of candidate joints. The dictionary can be arranged in the form of key-value pairs, where keys are camera ids and values are arrays of joints data structures from the camera. In such an embodiment, this dictionary is used in heuristics-based analysis to determine candidate joints and for assignment of joints to subjects. In such an embodiment, a high-level input, processing and output of the tracking engine 110 is illustrated in table 1. Details of the logic applied by the subject tracking engine 110 to detect subjects by combining candidate joints and track movement of subjects in the area of real space are presented in U.S. Pat. No. 10,055,853, issued 21 Aug. 2018, titled, “Subject Identification and Tracking Using Image Recognition Engine” which is incorporated herein by reference. The detected subjects are assigned unique identifiers (such as “subject id”) to track them throughout their presence in the area of real space.

TABLE 1
Inputs, processing and outputs from subject tracking engine 110 in
an example embodiment.

| Inputs | Processing | Output |
|---|---|---|
| Arrays of joints data | Create joints dictionary | List of identified |
| structures per image and for | Reproject joint positions | subjects in the |
| each joints data structure | in the fields of view of | real space at a |
| Unique ID | cameras with | moment in time |
| Confidence number | overlapping fields of | |
| Joint number | view to candidate joints | |
| (x, y) position in | | |
| image space | | |

### Subject Data Structure

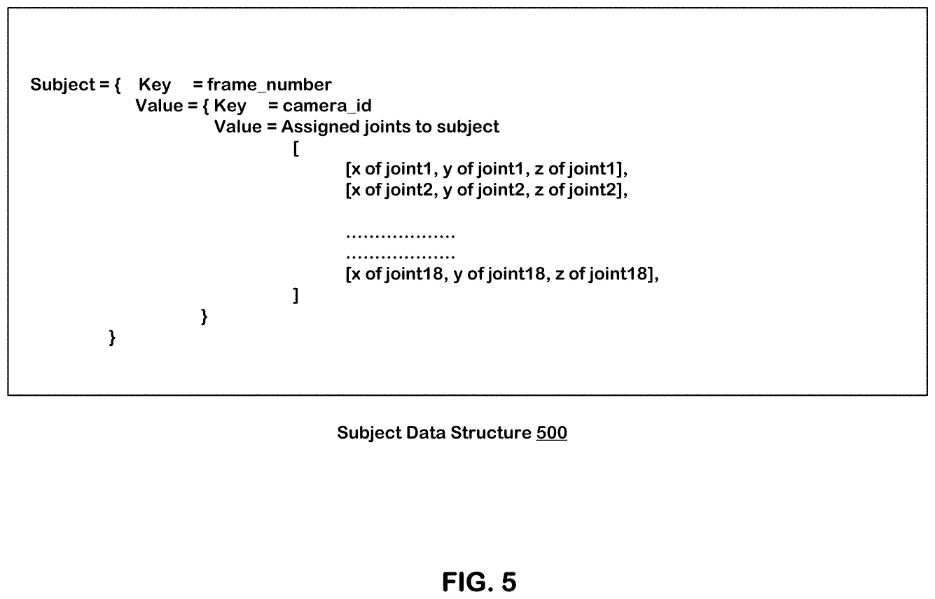

The subject tracking engine 110 uses heuristics to connect joints of subjects identified by the image recognition engines 112a-112n. In doing so, the subject tracking engine 110 detects new subjects and updates the locations of identified subjects (detected previously) by updating their respective joint locations. The subject tracking engine 110 uses triangulation techniques to project the locations of joints from 2D space coordinates (x, y) to 3D real space coordinates (x, y, z). FIG. 5 shows the subject data structure 500 used to store the subject. The subject data structure 500 stores the subject related data as a key-value dictionary. The key is a “frame_id” and the value is another key-value dictionary where key is the camera_id and value is a list of 18 joints (of the subject) with their locations in the real space. The subject data is stored in the subject database. Every new subject is also assigned a unique identifier that is used to access the subject's data in the subject database.

In one embodiment, the system identifies joints of a subject and creates a skeleton of the subject. The skeleton is projected into the real space indicating the position and orientation of the subject in the real space. This is also referred to as “pose estimation” in the field of machine vision. In one embodiment, the system displays orientations and positions of subjects in the real space on a graphical user interface (GUI). In one embodiment, the subject identification and image analysis are anonymous, i.e., a unique identifier assigned to a subject created through joints analysis does not identify personal identification information of the subject as described above.

For this embodiment, the joints constellation of an identified subject, produced by time sequence analysis of the joints data structures, can be used to locate the hand of the subject. For example, the location of a wrist joint alone, or a location based on a projection of a combination of a wrist joint with an elbow joint, can be used to identify the location of hand of an identified subject.

### Inventory Events

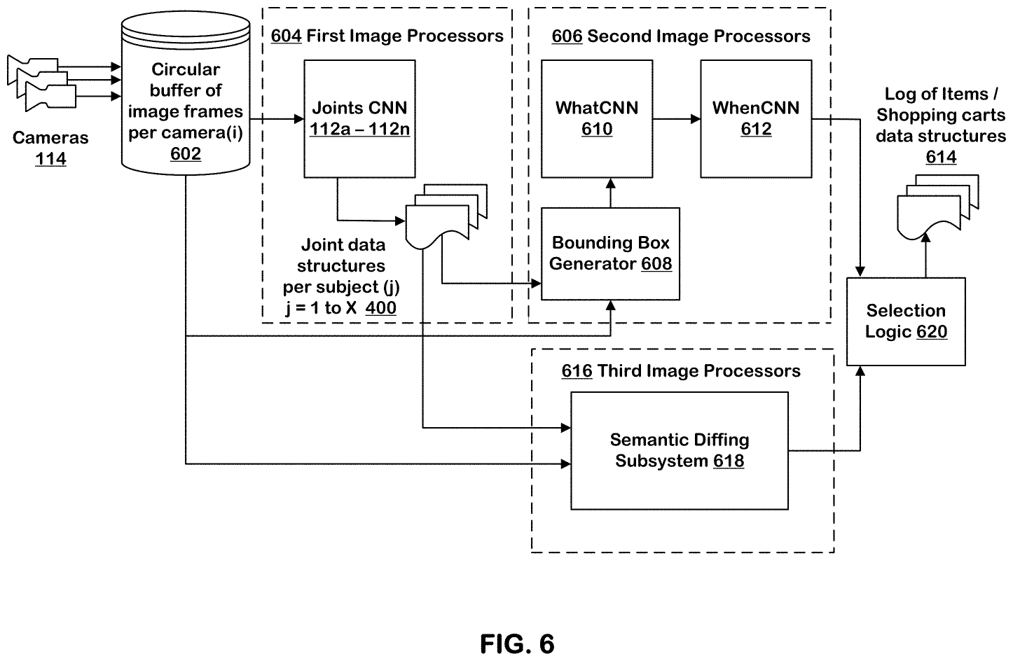

FIG. 6 presents subsystem components implementing the system for tracking changes by subjects in an area of real space. The system comprises of the plurality of cameras 114 producing respective sequences of image frames of corresponding fields of view in the real space. The field of view of each camera overlaps with the field of view of at least one other camera in the plurality of cameras as described above. In one embodiment, the sequences of image frames corresponding to the image frames produced by the plurality of cameras 114 are stored in a circular buffer 602 (also referred to as a ring buffer). Each image frame has a timestamp, identity of the camera (abbreviated as “camera_id”), and a frame identity (abbreviated as “frame_id”) along with the image data. Circular buffer 602 stores a set of consecutively timestamped image frames from respective cameras 114. In one embodiment, a separate circular buffer stores image frames per camera 114.

A first image processors 604 (also referred to as subject identification subsystem), includes first image recognition engines (also referred to as subject image recognition engines), receiving corresponding sequences of image frames from the plurality of cameras 114. The subject image recognition engines process image frames to generate first data sets that identify subjects and locations of subjects represented in the image frames in the corresponding sequences of image frames in the real space. In one embodiment, the subject image recognition engines 112a-112n are implemented as convolutional neural networks (CNNs) referred to as joints CNN 112a-112n. Joints of a single subject can appear in image frames of multiple cameras in a respective image channel. The outputs of joints CNNs 112a-112n corresponding to cameras with overlapping fields of view are combined to map the location of joints from 2D image coordinates of each camera to 3D coordinates of real space. The joints data structures 400 per subject (j) where j equals 1 to x, identify locations of joints of a subject (j) in the 2D space for each image. Some details of joints data structure 400 are presented in FIG. 4. The system can also determine the positions of joints of a subject in 3D coordinates of the area of real space by applying the three-dimensional scene generation as described above. The resulting 3D positions of the joints of subjects are stored in a subject data structure 500 presented in FIG. 5.

The second image processors 606 (also referred to as region proposals subsystem) include second image recognition engines (also referred to as foreground image recognition engines) receiving image frames from the sequences of image frames. The second image processors include logic to identify and classify foreground changes represented in the image frames in the corresponding sequences of image frames. The second image processors 606 include logic to process the first data sets (that identify subjects) to specify bounding boxes which include images of hands of the identified subjects in image frames in the sequences of image frames. As shown in FIG. 6, the region proposals subsystem includes a bounding box generator 608, a WhatCNN 610 and a WhenCNN 612. The joint data structures 400 and image frames per camera from the circular buffer 602 are given as input to the bounding box generator 608. The bounding box generator 608 implements the logic to process the data sets to specify bounding boxes which include images of hands of identified subjects in image frames in the sequences of image frames. The bounding box generator identifies locations of hands in each source image frame per camera using for example, locations of wrist joints (for respective hands) and elbow joints in the multi-joints subject data structures 500 corresponding to the respective source image frame. In one embodiment, in which the coordinates of the joints in subject data structure indicate location of joints in 3D real space coordinates, the bounding box generator maps the joint locations from 3D real space coordinates to 2D image coordinates in the image frames of respective source images.

The bounding box generator 608 creates bounding boxes for hands in image frames in a circular buffer per camera 114. In one embodiment, the bounding box is a 128 pixels (width) by 128 pixels (height) portion of the image frame with the hand located in the center of the bounding box. In other embodiments, the size of the bounding box is 64 pixels×64 pixels or 32 pixels×32 pixels. For m subjects in an image frame from a camera, there can be a maximum of 2m hands, thus 2m bounding boxes. However, in practice fewer than 2m hands are visible in an image frame because of occlusions due to other subjects or other objects. In one example embodiment, the hand locations of subjects are inferred from locations of elbow and wrist joints. For example, the right hand location of a subject is extrapolated using the location of the right elbow (identified as p1) and the right wrist (identified as p2) as extrapolation_amount*(p2−p1)+p2 where extrapolation_amount equals 0.4. In another embodiment, the joints CNN 112a-112n are trained using left and right hand images. Therefore, in such an embodiment, the joints CNN 112a-112n directly identify locations of hands in image frames per camera. The hand locations per image frame are used by the bounding box generator to create a bounding box per identified hand.

In one embodiment, the WhatCNN and the WhenCNN models are implemented convolutional neural networks (CNN). WhatCNN is a convolutional neural network trained to process the specified bounding boxes in the image frames to generate a classification of hands of the identified subjects. One trained WhatCNN processes image frames from one camera. In the example embodiment of the shopping store, for each hand in each image frame, the WhatCNN identifies whether the hand is empty. The WhatCNN also identifies a SKU (stock keeping unit) number of the inventory item in the hand, a confidence value indicating the item in the hand is a non-SKU item (i.e. it does not belong to the shopping store inventory) and a context of the hand location in the image frame.

The outputs of WhatCNN models 610 for all cameras 114 are processed by a single WhenCNN model 612 for a pre-determined window of time. In the example of a shopping store, the WhenCNN performs time series analysis for both hands of subjects to identify gestures by detected subjects and produce inventory events. The inventory events are stored as entries in the inventory events database 150. The inventory events identify whether a subject took a store inventory item from a shelf or put a store inventory item on a shelf. The technology disclosed uses the sequences of image frames produced by at least two cameras in the plurality of cameras to find a location of an inventory event. The WhenCNN executes analysis of data sets from sequences of image frames from at least two cameras to determine locations of inventory events in three dimensions and to identify item associated with the inventory event. A time series analysis of the output of WhenCNN per subject over a period of time is performed to identify gestures and produce inventory events and their time of occurrence. A non-maximum suppression (NMS) algorithm is used for this purpose. As one inventory event (i.e. put or take of an item by a subject) is produced by WhenCNN multiple times (both from the same camera and from multiple cameras), the NMS removes superfluous events for a subject. NMS is a rescoring technique comprising two main tasks: “matching loss” that penalizes superfluous detections and “joint processing” of neighbors to know if there is a better detection close-by.

The true events of takes and puts for each subject are further processed by calculating an average of the SKU logits for 30 image frames prior to the image frame with the true event. Finally, the arguments of the maxima (abbreviated arg max or argmax) is used to determine the largest value. The inventory item classified by the argmax value is used to identify the inventory item put on the shelf or taken from the shelf. The technology disclosed attributes the inventory event to a subject by assigning the inventory item associated with the inventory to a log data structure 614 (or shopping cart data structure) of the subject. The inventory item is added to a log of SKUs (also referred to as shopping cart or basket) of respective subjects. The image frame identifier “frame_id,” of the image frame which resulted in the inventory event detection is also stored with the identified SKU. The logic to attribute the inventory event to the customer matches the location of the inventory event to a location of one of the customers in the plurality of customers. For example, the image frame can be used to identify 3D position of the inventory event, represented by the position of the subject's hand in at least one point of time during the sequence that is classified as an inventory event using the subject data structure 500, which can be then used to determine the inventory location from where the item was taken from or put on. The technology disclosed uses the sequences of image frames produced by at least two cameras in the plurality of cameras to find a location of an inventory event and creates an inventory event data structure. In one embodiment, the inventory event data structure stores item identifier, a put or take indicator, coordinates in three dimensions of the area of real space and a time stamp. In one embodiment, the inventory events are stored as entries in the inventory events database 150.

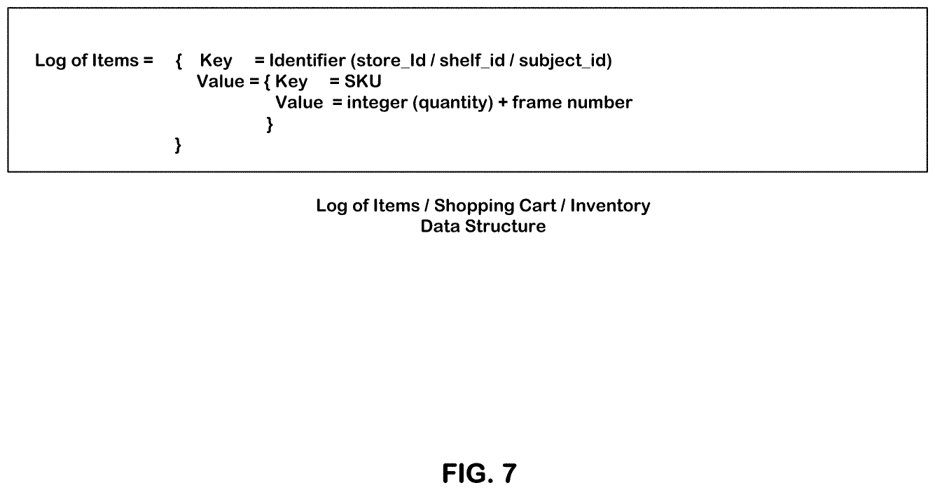

The locations of inventory events (indicating puts and takes of inventory items by subjects in an area of space) can be compared with a planogram or other map of the store to identify an inventory location, such as a shelf, from which the subject has taken the item or placed the item on. In one embodiment, the determination of a shelf in a shelf unit is performed by calculating a shortest distance from the position of the hand associated with the inventory event. This determination of shelf is then used to update the inventory data structure of the shelf. An example log of items data structure 614 (also referred to as a log data structure or shopping cart data structure) is shown in FIG. 7. This log of items data structure stores the inventory of a subject, shelf or a store as a key-value dictionary. The key is the unique identifier of a subject, shelf or a store and the value is another key value-value dictionary where key is the item identifier such as a stock keeping unit (SKU) and the value is a number identifying the quantity of item along with the “frame_id” of the image frame that resulted in the inventory event prediction. The frame identifier (“frame_id”) can be used to identify the image frame which resulted in identification of an inventory event resulting in association of the inventory item with the subject, shelf, or the store. In other embodiments, a “camera_id” identifying the source camera can also be stored in combination with the frame_id in the inventory data structure 614. In one embodiment, the “frame_id” is the subject identifier because the frame has the subject's hand in the bounding box. In other embodiments, other types of identifiers can be used to identify subjects such as a “subject id” which explicitly identifies a subject in the area of real space.

The system updates the log of items data structure of the subject as the subject takes items from shelves or puts items back on the shelf. In one embodiment, the system consolidates log of items data structure for the subjects, shelves and the store to update the respective data structure to reflect the quantities of items in subjects' shopping carts and the quantities of items positions on shelves. Over a period of time, this processing results in updates to the shelf inventory data structures for all inventory locations in the shopping store. Inventory data structures of inventory locations in the area of real space are consolidated to update the inventory data structure of the area of real space indicating the total number of items of each SKU in the store at that moment in time. In one embodiment, such updates are performed after each inventory event. In another embodiment, the store inventory data structures is updated periodically.

Detailed implementation of the implementations of WhatCNN and WhenCNN to detect inventory events is presented in U.S. Pat. No. 10,133,933, issued 20 Nov. 2018, titled, “Item Put and Take Detection Using Image Recognition” which is incorporated herein by reference as if fully set forth herein.

In one embodiment, the system includes third image processors 616 (also referred to as semantic diffing subsystem 618) to identify put and take inventory events in the area of real space. The third images processors can use the images from the same cameras 114 and the output of the first image processors (subject identification subsystem). The output of the semantic diffing subsystem is inventory put and take events for subjects in the area of real space. Detailed implementation of the implementations of semantic diffing subsystem to detect inventory events is presented in U.S. Pat. No. 10,127,438, issued 13 Nov. 2018, titled, “Predicting Inventory Events Using Semantic Diffing” which is incorporated herein by reference as if fully set forth herein. In this embodiment, the system can include a selection logic 620. For each true inventory event (take or put), the selection logic controller 620 selects the output from either the second image processors (region proposals subsystem) or the third image processors (semantic diffing subsystem). In one embodiment, the selection logic selects the output from an image processor with a higher confidence score for prediction of that inventory event.

As described in this application, take and put inventory events are generated as shoppers take items from the shelves or put items back on shelves. The inventory event data structure can also store a 3D location of the inventory event in the area of real space. In another embodiment, the location of the inventory event can be stored in a separate record which is linked to the inventory event record. The log of items data structure a type (or action) of inventory event. A “take” type inventory indicates that the subject took an item from a shelf while a “put” type inventory event indicates that subject placed an item back on the shelf. A take inventory event results in the item to be included in the log of items or shopping cart data structure of the subject. The SKU identifier uniquely identifies an item in the store inventory. The quantity field indicates a number of the item taken from the shelf or placed on the shelf. The system also records the confidence level of the inventory event. For example, the confidence level value can range from 0 to 1 floating point number. A higher value of the confidence number indicates that the system predicated the inventory event with a higher probability of the occurrence of the event. A lower value of the confidence score indicates that the system predicated the inventory event with a lower probability score. The following is an example data structure for storing inventory events in the log of inventory events also referred to as inventory events database 150.

{

action: ‘take’/‘put’
sku_id: uuid,
quantity: 1,
confidence: float

}

### Check-Out Events

The system includes logic to detect check-out events for subjects in the area of real space. The system processes sensor data (such as images received from cameras 114) to track locations and movements of individual subjects in the area of real space. A check-out event for a particular individual or a particular subject is generated when the system tracks location of the subject to a particular region (e.g., an exit from the area of real space or an area around the exit from the area of real space). In one embodiment, the system detects movement of a subject towards an exit from the area of real space and generates a check-out event when the subject is within a pre-determined distance from the exit (e.g. 5 meters). In response to the check-out event for the subject, the system generates a digital receipt for the subject and transmits the digital receipt to a device (e.g., a mobile computing device) associated with the subject. In another embodiment, the system can generate the digital receipt when the subject moves out of the area of real space (e.g., the shopping store) through an exit. The digital receipt includes list of items based on the items in the log of items of the subject. The digital receipt can include graphical constructs for display on the device prompting input from the subject to request changes (e.g., refund) in the list of items. In the following section, we present the system and process to generate the digital receipts and to process refund requests received from the subjects.

### Digital Receipts

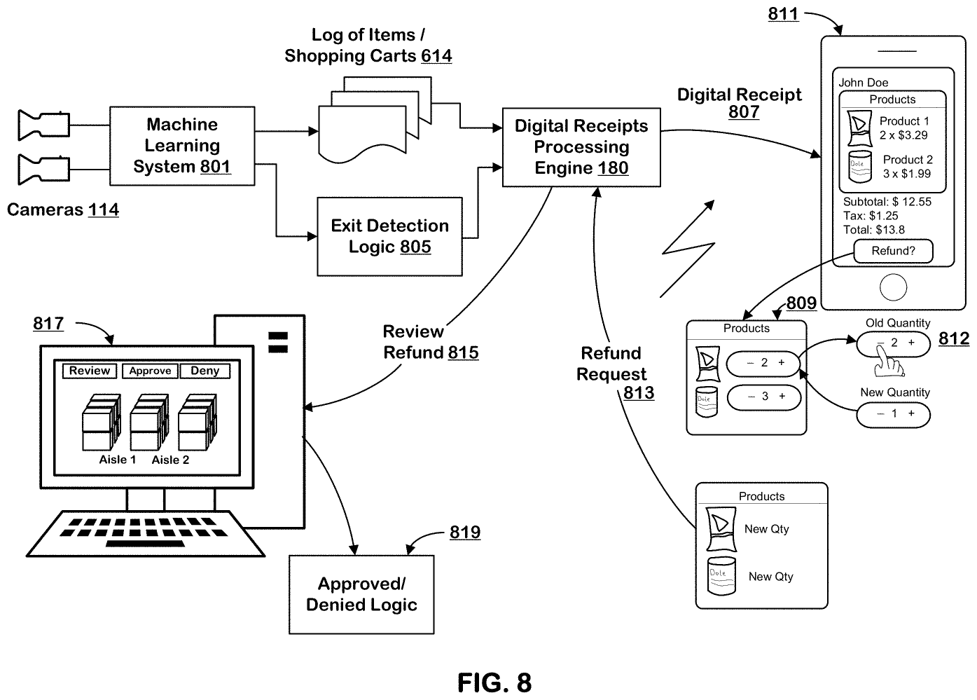

We now present a high-level architecture of a system that can generate digital receipts, send digital receipts to computing devices associated with subjects and process refund requests. The digital receipts can comprise electronic documents that include or include links to functional logic, such as computer programs executable on a user device or in a server, implementing a graphical user interface and procedures supporting challenges to and verification of entries in the digital receipt in an automated system. The architecture of the system is illustrated in FIG. 8 in which cameras 114 capture sequences of images of the area of real space. The sequences of images can have overlapping fields of view. The system can also use sensors to generate sequences of sensor data with overlapping fields of view. A machine learning system 801 includes the logic to process sequences of sensor data to identify inventory events in the area of real space. An example of such system is described above with reference to FIG. 6. The machine learning system 801 can generate log of items or shopping cart data 614 for individual subjects. The system can check-in the subjects as described above. The system includes exit detection logic 805 that can generate check-out events for subjects that are tracked to a particular region such as an exit or an area around an exit in the area of real space.

The digital receipts processing engine 180 can include logic to generate a digital receipt 807. A digital receipt includes list of items based on the item in the log of items for the particular subject. An example data structure of representing an item in a digital receipt is presented below:

{

refund_status: NONE/PENDING/ACCEPTED/DENIED
purchase_list: [

{

sku_id: uuid,
quantity: Number
price: Number

},
...

],
total: Number,
tax: Number,
subtotal: Number

}

The digital receipt includes a refund_status field which can be assigned a values such as “PENDING”, “ACCEPTED”, “DENIED” or “NONE”. A purchase_list can be an array of a list type data structures containing an element per item in the log of items of the subject. For each item, the digital receipt includes information such as the stock keeping unit identifier (sku_id), a quantity, and a price. The digital receipt includes a “subtotal” which is the sum of the price of all items multiplied by their respective quantities. A “total” can be calculated by including the “tax” amount in the “subtotal” amount. The digital receipt can also include other fields such as names of the items, the name of the subject, a date and time of receipt generation, a store identifier including the store name and address from where the subject purchased the items, the loyalty points of the subject, etc.

The digital receipts processing engine 180 includes the logic to transmit the digital receipt to a device 811 associated with the particular subject for which the digital receipt is generated. The device 811 can be a mobile computing device such as a cell phone, a tablet, etc. The digital receipts processing engine 180 can also send the digital receipt via email to the subject who can then open the digital receipt in an email client or a web browser using a computing device such as a desktop computer, laptop computer or a mobile computing device.

The digital receipt can be displayed on the mobile computing device 811 as shown in FIG. 8. The digital receipt can also include links to procedures supporting interaction with the digital receipt linked with graphical constructs such as buttons, widgets, etc. for display on the device prompting input to request changes in the list of items and other interactions. For example, the digital receipt can include a “Refund” button as shown in FIG. 8. The subject can press the refund button to request refund for one or more items in the list of items in the digital receipt. Graphical user interface that invokes a procedure to validate the entry in the digital receipt such as that described herein. In one embodiment, the digital receipts are in the form of an electronic document such as in Extensible Markup Language (XML) including embedded software supporting the procedures, or links to software supporting the procedures performed using the graphical user interface. The document is displayed to the user in a browser and the items in the log of items are displayed in the document with links to the graphical constructs (i.e., one or more buttons to process refund). In another embodiment, the digital receipt is displayed using an application (such as a store app) on the computing device 811. The application executing on the device processes the digital receipt and receives input from the user and invokes the procedures linked to the graphic user interface to support refund requests or other interactions.

In one embodiment, pressing the refund button on the digital receipt brings up a user interface 809 which displays the items in the digital receipt and their respective quantities. The quantities of items are displayed as one or more graphical construct 812 with “+” and “−” symbols. A graphical construct displays current quantity of respective item and allows the subject to press “+” symbol on the graphical construct 812 to increase the quantity of item and “−” symbol to decrease the quantity of item. The new quantities of items are sent with a refund request message 813 to the digital receipts processing engine 180. An example of a data structure that can be used to send the refund request in the refund request message 813 is given below:

{

sku_id: uuid
quantity: number

}

The digital receipts processing engine 180 includes logic responsive to messages from the device for the particular subject requesting a change in the list of items to access an entry in the log of inventory events for the particular subject corresponding to the requested change. The logic compares the classification confidence score in entry with a confidence threshold. If the confidence score is lower than the threshold, the system accepts the change requested by the subject and updates the digital receipt. If the classification confidence score is above the threshold, the system includes logic to retrieve a set of sensor data (or images in the sequences of images from the cameras) from the stored sequences of sensor data and send a review refund message 815 to a monitor device 817 for review by a human operator. Finally, upon review the approved or denied logic 819 can update the digital receipt if required and send a message to the computing device 811 with the results of the review process.

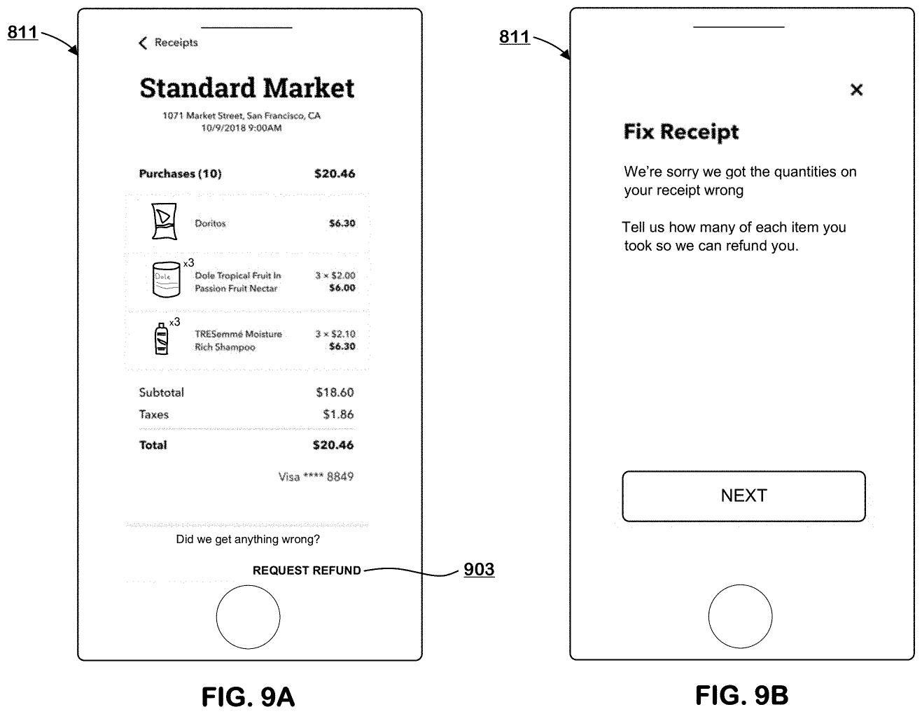

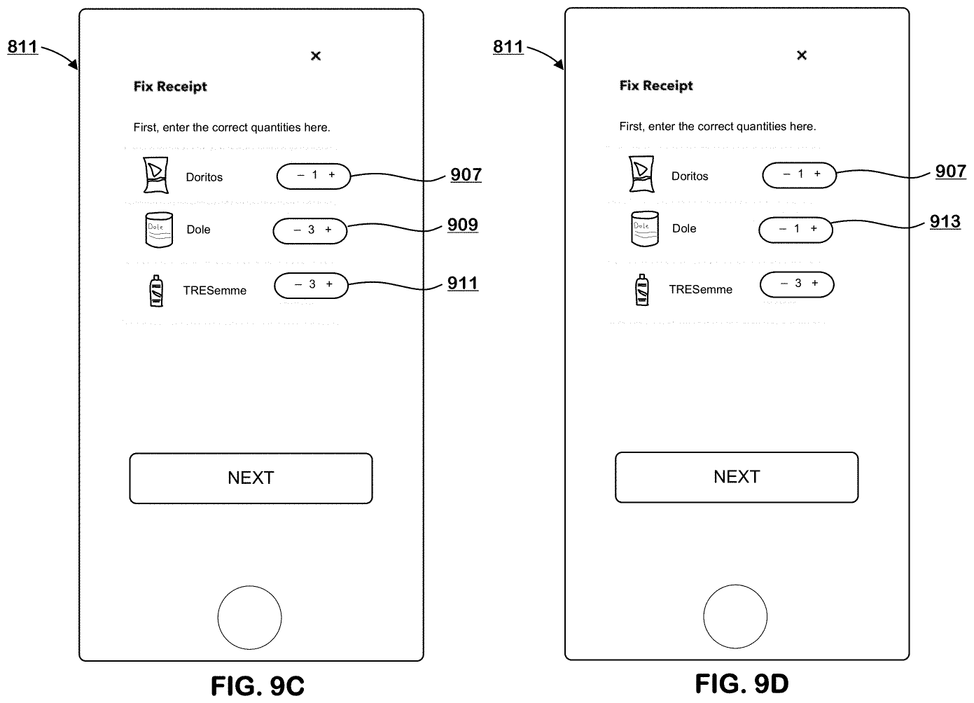

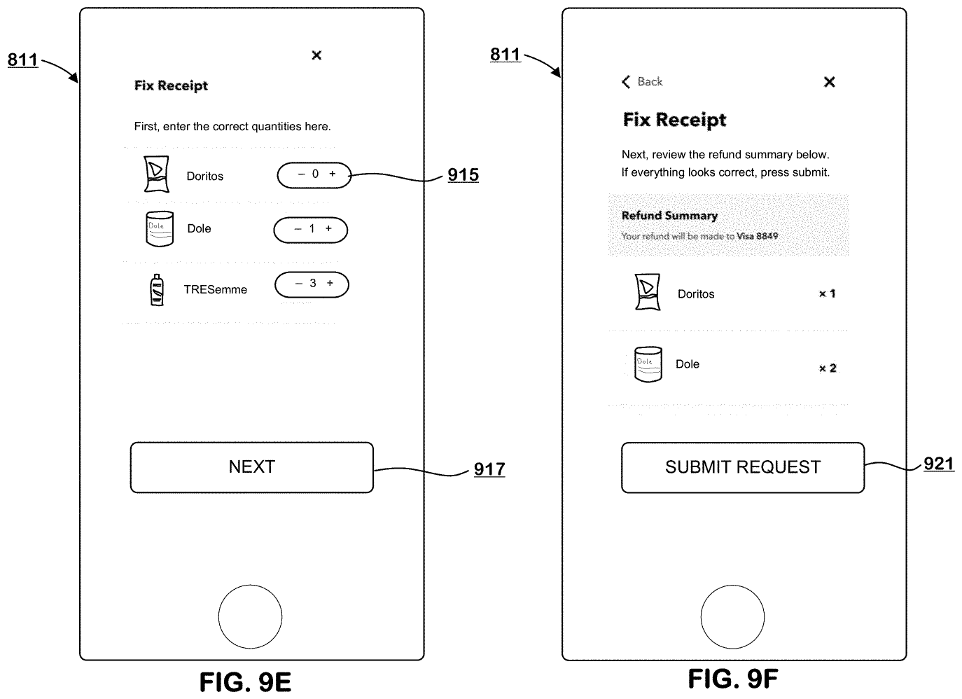

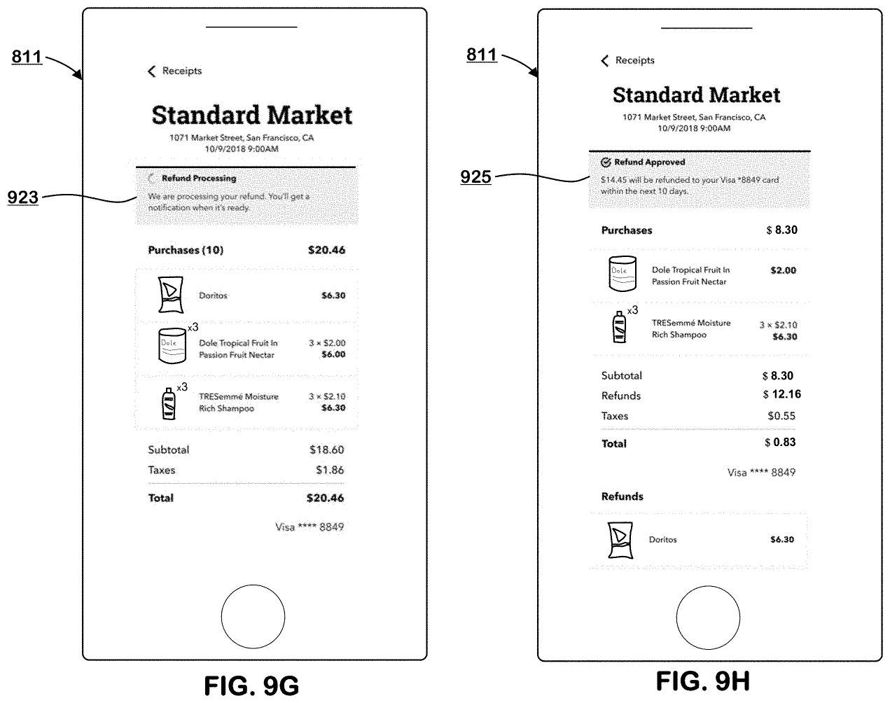

FIGS. 9A to 9H present a sequence of user interface examples in which a digital receipt is displayed on the computing device 811 and a subject provides input to request refund. FIG. 9A shows an example digital receipt displayed on the user interface of the mobile computing device 811. The digital receipt lists the items bought by the customer. In this example, the digital receipt displays three items bought by the subject along with their pictures, names and quantities. For items that have a quantity of more than one, the quantity is displayed at the top right corner of the picture of the item with a multiplication sign such as “x3” which means the customer has bought this item in a quantity of three. The digital receipt shows a subtotal amount which is calculated by summing the amounts of individual items on the digital receipt multiplied by their respective quantities. The taxes are calculated by using the applicable taxes. For example, in this example, the tax is calculated as 10 percent of the subtotal amount. A total amount is calculated by summing the subtotal amount and the tax amount. The digital receipt can display other information such as the name and address of the store from where the items are purchased, the date and time of purchase. The digital receipt can display information about the payment such as the card type and last four digits of the credit card from where the payment was made. Note that the payment information can be stored in the user accounts database and can be linked to the subject using the check-in procedure described above.

The digital receipt can display one or more buttons or links that allow the subject to request changes in the digital receipt. For example, a graphical construct (such as a button or a link) 903 labelled as “Request Refund” can be clicked or pressed by the subject to initiate the refund request process. When the subject presses the button 903, a next user interface is displayed as shown in FIG. 9B. The user can press the “NEXT” button in FIG. 9B which displays the user interface as shown in FIG. 9C. For each item in the digital receipt a graphical construct is displayed such as 907, 909, and 911 as shown in FIG. 9C. The graphical construct 907 displays the current quantity of the item in the center with “−” and “+” symbols on the left and right side of the quantity respectively. The subject can press or click on the “−” and “+” symbols to decrease or increase the quantity of the item. For example, suppose the subject has bought one item of “Dole” cans but the digital receipt shows that subject has taken three cans of “Dole” as shown in the graphical construct 909. The subject presses “−” symbol on the graphical construct 909 to reduce the quantity to one as shown in graphical construct 913 in FIG. 9D. Similarly, the subject reduces the quantity of “Doritos” item from one as shown in the graphical construct 907 in FIG. 9D to zero as shown in a graphical construct 915 in FIG. 9E. The subject presses the “NEXT” button 917 in FIG. 9E after correcting the quantities of items in the digital receipt. FIG. 9F shows the user interface in which a refund summary is displayed to the subject. FIG. 9F shows the items and their quantities for which the subject has requested a refund. The subject presses the “SUBMIT REQUEST” button 921 in FIG. 9F to submit refund request. A message 923 (FIG. 9G) is displayed on the user interface of the digital receipt to inform the subject that her refund request is being processed by the system. When the refund request is processed, a message 925 is displayed as shown in FIG. 9H that the refund request has been approved. The digital receipt now displays corrected quantities of items and a refund amount can also be displayed.

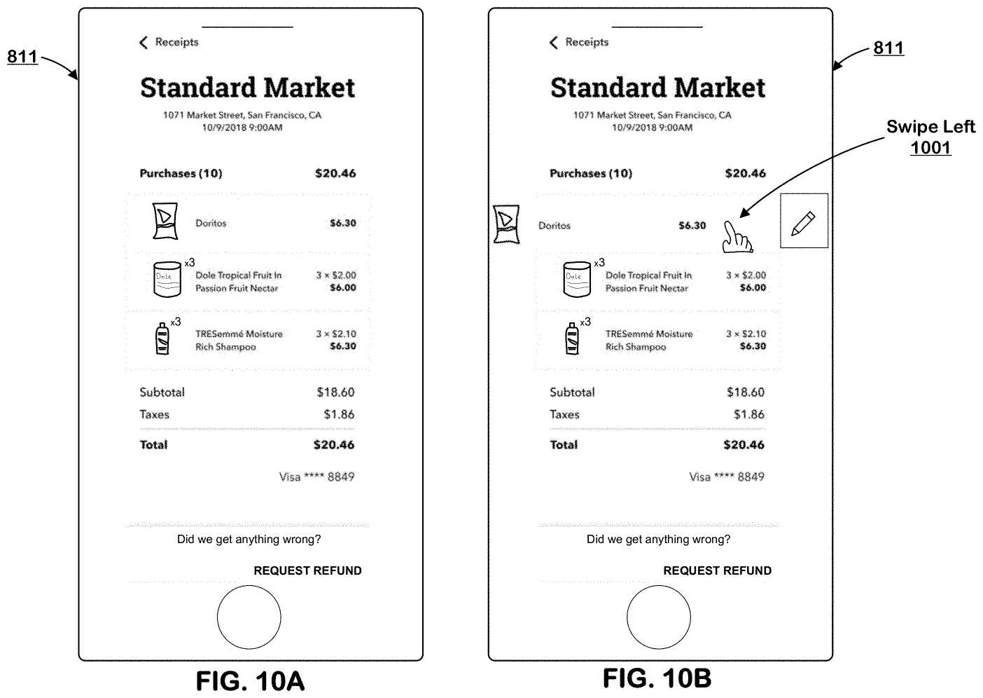

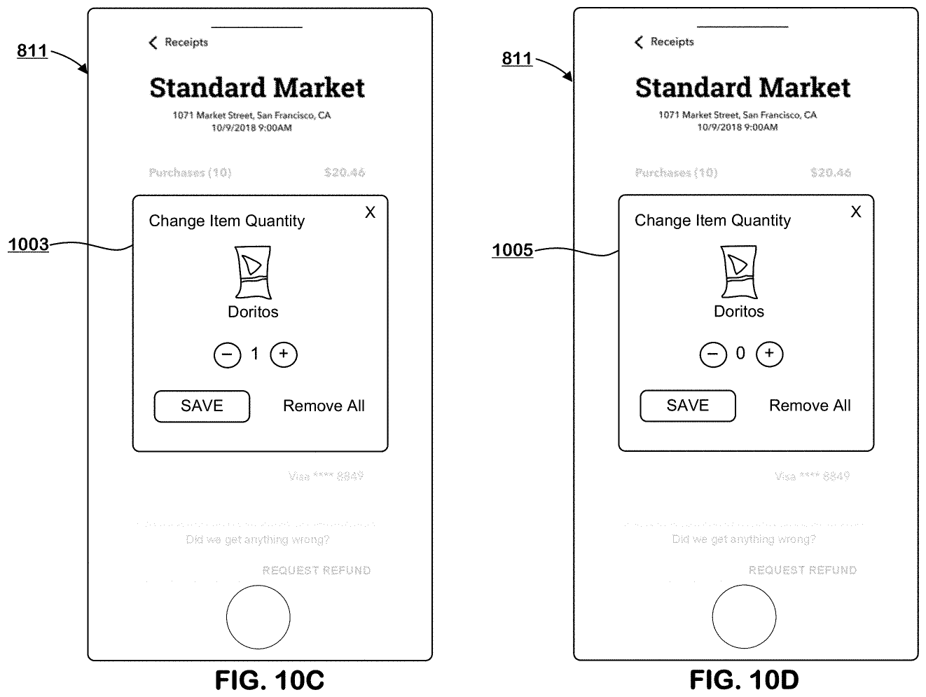

FIGS. 10A to 10D present an example user interface of digital receipt in which the subject can request for a refund using a “swipe” gesture. FIG. 10A illustrates the digital receipt which is similar to the digital receipt shown in FIG. 9A. In this example, the subject can perform the swipe left gesture 1001 to request refund for an item as shown in FIG. 10B. When the user performs the swipe left gesture, a graphical construct 1003 is displayed on the user interface as shown in FIG. 10C. The graphical construct 1003 can display a name, picture or other identifier of the item. It also displays the current quantity of the item positioned between “−” and “+” symbols. The subject can press or click on “−” and “+” symbols to decrease or increase the quantity of the item. For example, the subject decreases the quantity from one in FIG. 10C to zero in FIG. 10D. The subject can then press the “SAVE” button in the graphical construct 1005 to submit the refund request. The refund message is then sent to the server (such as the digital receipts processing engine) which processes the refund request as described above.

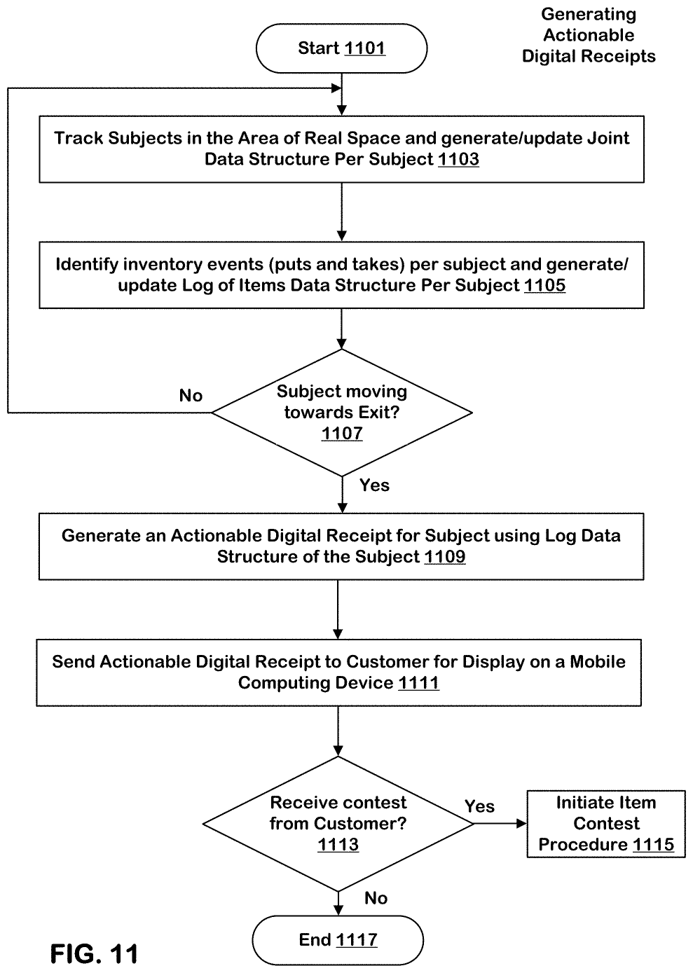

We now present processes to generate actionable digital receipts, receive and display digital receipts on shoppers' computing devices, and process item contest (such as refund) requests on the server side. The processes are presented as flowcharts in FIGS. 11, 12 and 13. The logic presented by the flowcharts can be implemented using processors programmed using computer programs stored in memory accessible to the computer systems and executable by the processors, by dedicated logic hardware, including field programmable integrated circuits, and by combinations of dedicated logic hardware and computer programs. As with all flowcharts herein, it will be appreciated that many of the steps can be combined, performed in parallel or performed in a different sequence without affecting the functions achieved. In some cases, as the reader will appreciate, a re-arrangement of steps will achieve the same results only if certain other changes are made as well. In other cases, as the reader will appreciate, a re-arrangement of steps will achieve the same results only if certain conditions are satisfied. Furthermore, it will be appreciated that the flow chart herein shows only steps that are pertinent to an understanding of the invention, and it will be understood that numerous additional steps for accomplishing other functions can be performed before, after and between those shown.

The flowchart in FIG. 11 presents process steps for generating digital receipts. The process starts at step 1101. At a step 1103 the system tracks subjects in the area of real space. In one embodiment, the system tracks subjects in the area of real space using the logic implemented in the subject tracking engine 110. The subject tracking engine 110 can identify and track subjects by 3D scene generation and creating and updating subject data structures. The system determines inventory events for subjects (such as puts and takes of items) at a step 1105. The inventory events are stored in logs of inventory events. The system determines items taken by the subjects and stores this information in the log of items data structure per subject. In one embodiment, the system performs steps 1103 and 1105 at regular intervals (such as every thirty seconds, every fifteen seconds or every second) and updates the subject data structures, logs of inventory events and logs of items.

At a step 1107, the system detects check-out events for subjects. A check-out event is detected if a subject is moving towards an exit from the area of real space or the subject is in an exit or around an exit from the area of real space. If the condition is false, the system performs steps 1103 and 1005 at regular intervals for all subjects in the area of real space. If the condition at step 1107 is true for a subject, i.e., a subject is in an exit or around an exit, the system performs the following process steps for the subject. At a step 1109, the system generates a digital receipt (also referred to as an actionable digital receipt) for the subject using the log of items data structure of the subject for which the check-out event is detected. At a step 1111, the system sends actionable digital receipt for display on a mobile computing device associated with the subject. The mobile device is associated with the subject during a check-in process as described earlier. In other embodiments, the system can send the digital receipt via email to an email address associated with the subject. The subject can contest the items on the digital receipt, for example, the subject can request a refund for one or more items. In one embodiment, the system can accept the refund requests within a pre-determined time duration after the sending the digital receipt, for example, one week, two weeks, and so on. The subject can review the digital receipts for her shopping trips to the shopping store in a shopping history user interface within the store app or in a browser page. From the list of shopping receipts displayed in the user interface of the app or in the browser page, she can select a digital receipt to open and review items and their quantities. The subject can initiate the contest process by using graphical constructs to change the quantities of items or remove items from the digital receipt. At a step 1113, the system processes a contest received from the subject. Before processing the contest, the system can check if the contest request is within the allowed time frame. If so, the system can initiate the contest procedure at a step 1115. The process ends at a step 1117.

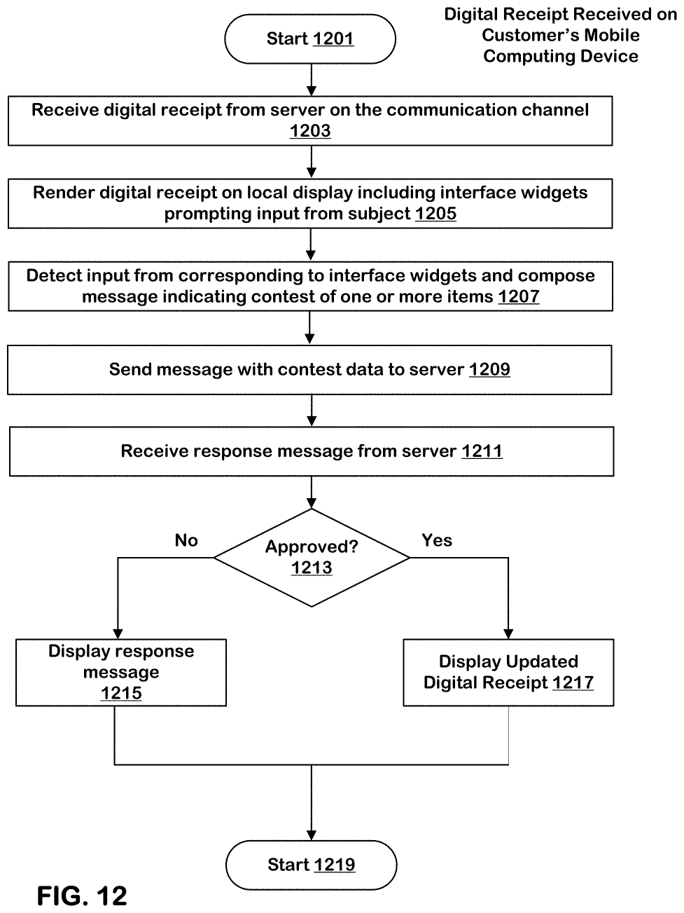

FIG. 12 presents a flowchart of process steps to send a contest from the actionable digital receipt displayed on a mobile computing device to the server. The process starts at a step 1201. At a step 1203, the digital receipt from the server is received at the mobile computing device. A notification can be generated to alert the subject that a digital receipt has been received. The notification can include a sound alarm, or a message displayed on the user interface, prompting the subject to open the digital receipt. The digital receipt is displayed on the user interface of the mobile computing device at a step 1205. At a step 1207, the actionable digital receipt detects an input from the subject from graphical constructs such as button or widgets. The contest such as a refund request is sent to the server (also referred to as digital receipts processing engine) in a step 1209. At a step 1211, a response message from the server is received. If the contest request is approved (step 1213), an updated digital receipt is displayed to the user at a step 1217. Otherwise, a message is displayed at a step 1215 that the refund request is not approved. The message can also include a contact number such as a phone number or an email address of the store so that customer can contact the store to escalate the refund request. The process ends at a step 1219.

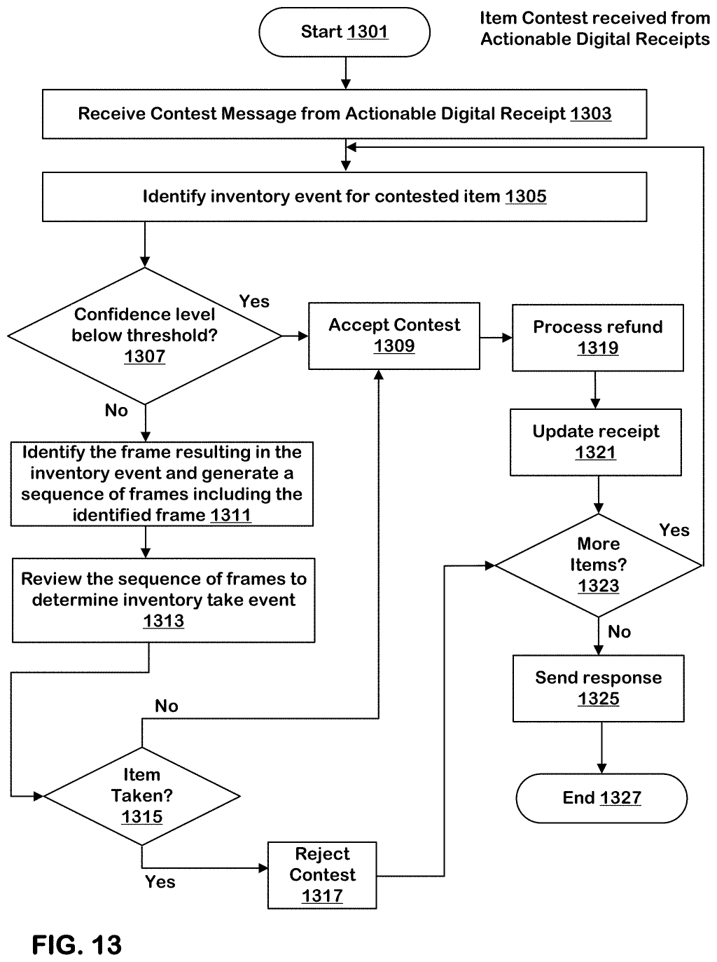

FIG. 13 presents a flowchart of process steps at the server side to process the item contest message received from the actionable digital receipt displayed at the client side (such as a mobile computing device). The process starts at a step 1301. At a step 1303, the server (e.g., the digital receipts processing engine) receives contest message from actionable digital receipt from the computing device associated with a particular subject. At a step 1305, the system accesses an entry in the log of inventory events for the particular subject corresponding to the requested change. The system compares the confidence score in the accessed entry in the log of inventory events with a threshold (step 1307). In one embodiment, the confidence score can be a real number between 0 and 1. A threshold can be set at a value of 0.5. Other values of the threshold greater than or less than 0.5 can be set. If the confidence score for the inventory event is below the threshold, the system accepts the contest (such as a refund) at a step 1309. Otherwise, if the confidence score is not below the threshold, the system retrieves a set of sensor data from the stored sequences of sensor data corresponding to the identified inventory event. In one embodiment, the system determines a frame number of the sensor data (or the image frame) that resulted in the “take” detection of the item in the inventory event (step 1311). The system can use the frame identifier (such as frame_id) stored in the entry in the log of items for the subject corresponding to the item for which the subject has requested a refund to retrieve the sensor data. An example data structure to store the log of items is shown above in FIG. 7 which includes the frame number that resulted in the item take event. The system may also retrieve a set of frames before and after the frame identified in the log of items entry. For example, in one embodiment, the system can retrieve fifty frames before and fifty frames after the identified frame to form a sequence of a hundred and one frames including the frame identified by the frame identifier in the entry in the log of items. In other embodiments, less than fifty or more than fifty frames can be retrieved before and after the identified frame in the sequence of frames.

This set of sensor data (or set of frames) is then reviewed to determine whether the subject has taken the item from the shelf. In one embodiment, the system sends the set of sensor data or a link to the set of sensor data to a monitor device for review by human operator (step 1313). If the review determines that the item was taken by the subject from the shelf (step 1315) then the system rejects the refund request (step 1317). Otherwise, the system accepts the refund request (step 1309). At a step 1319, the system processes the refund request by sending the refund amount to the customer via the payment method selected by the subject in her user account record. The system updates the digital receipt of the customer with updated items and their quantities (step 1321). If there are more items in the refund request (step 1323) the system repeats the above process steps, starting at the step 1305. If there are no more items to be processed in the refund request, the system send the response message to the customer informing her about the results of the refund process (step 1325). The message can include updated digital receipt and details of the refund if the refund request is approved. The process ends at a step 1327.

### Network Configuration

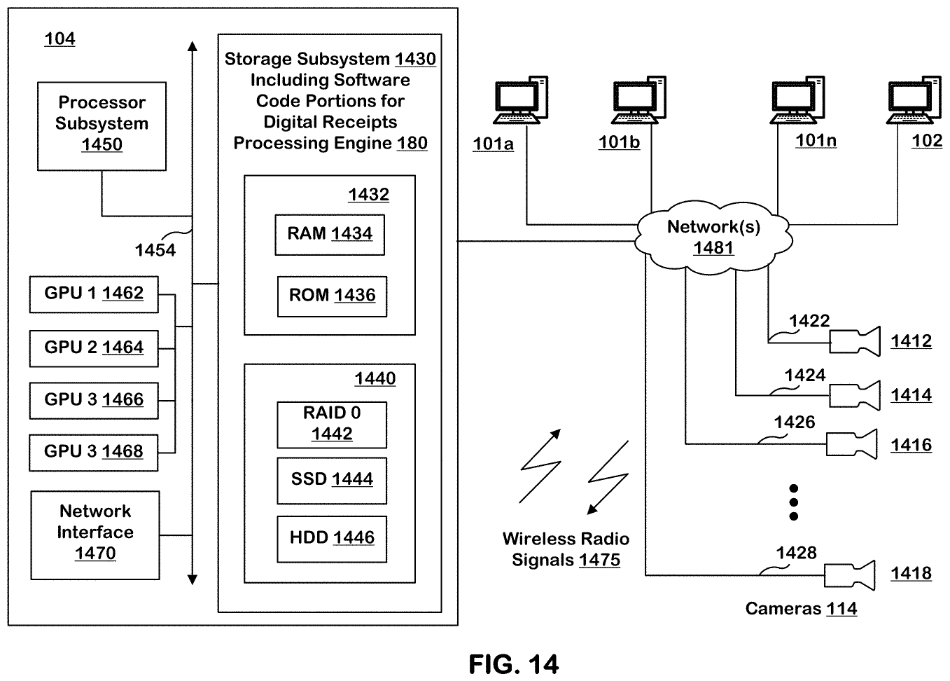

FIG. 14 presents an architecture of a network hosting the digital receipts processing engine 180 which is hosted on the network node 104. The system includes a plurality of network nodes 101a, 101b, 101n, and 102 in the illustrated embodiment. In such an embodiment, the network nodes are also referred to as processing platforms. Processing platforms (network nodes) 104, 101a-101n, and 102 and cameras 1412, 1414, 1416, . . . 1418 (collectively referred to as cameras 114) are connected to network(s) 1481.

FIG. 14 shows a plurality of cameras 1412, 1414, 1416, . . . 1418 connected to the network(s). A large number of cameras can be deployed in particular systems. In one embodiment, the cameras 1412 to 1418 are connected to the network(s) 1481 using Ethernet-based connectors 1422, 1424, 1426, and 1428, respectively. In such an embodiment, the Ethernet-based connectors have a data transfer speed of 1 gigabit per second, also referred to as Gigabit Ethernet. It is understood that in other embodiments, cameras 114 are connected to the network using other types of network connections which can have a faster or slower data transfer rate than Gigabit Ethernet. Also, in alternative embodiments, a set of cameras can be connected directly to each processing platform, and the processing platforms can be coupled to a network.

Storage subsystem 1430 stores the basic programming and data constructs that provide the functionality of certain embodiments of the present invention. For example, the various modules implementing the functionality of the digital receipts processing engine 180 may be stored in storage subsystem 1430. The storage subsystem 1430 is an example of a computer readable memory comprising a non-transitory data storage medium, having computer instructions stored in the memory executable by a computer to perform all or any combination of the data processing and image processing functions described herein, including logic to link subjects in an area of real space with a user account, to determine locations of identified subjects represented in the images, match the identified subjects with user accounts by identifying locations of mobile computing devices executing client applications in the area of real space by processes as described herein. In other examples, the computer instructions can be stored in other types of memory, including portable memory, that comprise a non-transitory data storage medium or media, readable by a computer.

These software modules are generally executed by a processor subsystem 1450. A host memory subsystem 1432 typically includes a number of memories including a main random access memory (RAM) 1434 for storage of instructions and data during program execution and a read-only memory (ROM) 1436 in which fixed instructions are stored. In one embodiment, the RAM 1434 is used as a buffer for storing log of items, inventory events and other related data.

A file storage subsystem 1440 provides persistent storage for program and data files. In an example embodiment, the storage subsystem 1440 includes four 120 Gigabyte (GB) solid state disks (SSD) in a RAID 0 (redundant array of independent disks) arrangement identified by a numeral 1442. In the example embodiment, subject data in the subject database 140, inventory events data in the inventory events database 150, item logs data in the log of items database 160, and the digital receipts data in the actionable digital receipts database 170 which is not in RAM is stored in RAID 0. In the example embodiment, the hard disk drive (HDD) 1446 is slower in access speed than the RAID 0 1442 storage. The solid state disk (SSD) 1444 contains the operating system and related files for the digital receipts processing engine 180.

In an example configuration, four cameras 1412, 1414, 1416, 1418, are connected to the processing platform (network node) 104. Each camera has a dedicated graphics processing unit GPU 1 1462, GPU 2 1464, GPU 3 1466, and GPU 4 1468, to process image frames sent by the camera. It is understood that fewer than or more than three cameras can be connected per processing platform. Accordingly, fewer or more GPUs are configured in the network node so that each camera has a dedicated GPU for processing the image frames received from the camera. The processor subsystem 1450, the storage subsystem 1430 and the GPUs 1462, 1464, 1466, and 1468 communicate using the bus subsystem 1454.

A network interface subsystem 1470 is connected to the bus subsystem 1454 forming part of the processing platform (network node) 104. Network interface subsystem 1470 provides an interface to outside networks, including an interface to corresponding interface devices in other computer systems. The network interface subsystem 1470 allows the processing platform to communicate over the network either by using cables (or wires) or wirelessly. The wireless radio signals 1475 emitted by the mobile computing devices 120 in the area of real space are received (via the wireless access points) by the network interface subsystem 1470 for processing by the matching engine. Similarly, the mobile computing devices 120 can receive the digital receipts sent by the digital receipts processing engine over wireless radio signals 1475. A number of peripheral devices such as user interface output devices and user interface input devices are also connected to the bus subsystem 1454 forming part of the processing platform (network node) 104. These subsystems and devices are intentionally not shown in FIG. 14 to improve the clarity of the description. Although bus subsystem 1454 is shown schematically as a single bus, alternative embodiments of the bus subsystem may use multiple busses.

In one embodiment, the cameras 114 can be implemented using Chameleon3 1.3 MP Color USB3 Vision (Sony ICX445), having a resolution of 1288×964, a frame rate of 30 FPS, and at 1.3 MegaPixels per image, with Varifocal Lens having a working distance (mm) of 300-∞, a field of view field of view with a ⅓″ sensor of 98.2°-23.8°.

Any data structures and code described or referenced above are stored according to many implementations in computer readable memory, which comprises a non-transitory computer-readable storage medium, which may be any device or medium that can store code and/or data for use by a computer system. This includes, but is not limited to, volatile memory, non-volatile memory, application-specific integrated circuits (ASICs), field-programmable gate arrays (FPGAs), magnetic and optical storage devices such as disk drives, magnetic tape, CDs (compact discs), DVDs (digital versatile discs or digital video discs), or other media capable of storing computer-readable media now known or later developed.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein. The scope of the technology disclosed is defined by the appended claims.

What is claimed is:

1. A system for automated shopping, comprising:
a processing system receiving a sequences of sensor data of an area of real space, and the processing system including:
logic to process the sequences of sensor data to identify inventory events in the area of real space linked to individual subjects, and to maintain inventory events as logs of inventory events, the inventory events including an item identifier and a classification confidence score for the item, the processing system storing sensor data from the sequences of sensor data from which the inventory events are identified;
logic to maintain logs of items for individual subjects, and in response to a check-out event for a particular subject, to generate a digital receipt and transmit the digital receipt to a device associated with a particular subject, the digital receipt including list of items based on the items in the log of items for the particular subject with links to graphical constructs for display on the device prompting input to request changes in the list of items; and
logic responsive to messages from the device for the particular subject requesting a change in the list of items, to access an entry in the log of inventory events for the particular subject corresponding to the requested change, compare the classification confidence score in entry with a confidence threshold, and in the event the confidence score is lower than the threshold, to accept the change and update the digital receipt, and in the event the confidence score is higher than the threshold, to identify the inventory event corresponding to the change and retrieve a set of sensor data from the stored sequences of sensor data for corroboration of the identified inventory event.

2. The system of claim 1, the processing system including logic to send the set of sensor data or a link to the set of sensor data to a monitor device for review by human operator.

3. The system of claim 1, the processing system including logic to send a message to the device acknowledging the requested change.

4. The system of claim 1, the processing system including logic operable in the event the confidence score is lower than the threshold, to send a message to the device accepting the requested change.

5. The system of claim 1, the processing system including logic operable in the event the confidence score is higher than the threshold, to send a message to the device indicating requested change is under review.

6. The system of claim 1, the processing system including logic to process the sensor data to track individual subjects in the area of real space, and to link individual subjects to inventory events, and logic to establish a communication link to devices associated with the individual subjects, on which to receive said messages from particular subjects and to send messages to particular subjects.

7. The system of claim 1, the processing system including logic to process the sensor data to track locations of individual subjects in the area of real space, and signal said check-out event for a particular subject if the location of the particular subject is tracked to a particular region of the area of real space.

8. The system of claim 1, the processing system including logic to establish a communication link to devices associated with the individual subjects, on which to receive messages from particular subjects interpreted as said check-out event.

9. The system of claim 1, wherein the sequences of sensor data comprise a plurality of sequences of images having overlapping fields of view.

10. The system of claim 1, wherein the log of items includes puts and takes of inventory items.

11. A method for automated shopping, the method including:
receiving a sequences of sensor data of an area of real space,
processing the sequences of sensor data to identify inventory events in the area of real space linked to individual subjects, and maintain inventory events as logs of inventory events, the inventory events including an item identifier and a classification confidence score for the item,
storing sensor data from the sequences of sensor data from which the inventory events are identified;
maintaining logs of items for individual subjects, and in response to a check-out event for a particular subject, generating a digital receipt and transmit the digital receipt to a device associated with a particular subject, the digital receipt including list of items based on the items in the log of items for the particular subject with links to graphical constructs for display on the device prompting input to request changes in the list of items; and
responding to messages from the device for the particular subject requesting a change in the list of items by accessing an entry in the log of inventory events for the particular subject corresponding to the requested change,
comparing the classification confidence score in entry with a confidence threshold, and in the event the confidence score is lower than the threshold, accepting the change and updating the digital receipt, and in the event the confidence score is higher than the threshold, identifying the inventory event corresponding to the change and retrieving a set of sensor data from the stored sequences of sensor data for corroboration of the identified inventory event.

12. The method of claim 11, the method further including sending the set of sensor data or a link to the set of sensor data to a monitor device for review by human operator.

13. The method of claim 11, the method further including sending a message to the device acknowledging the requested change.

14. The method of claim 11, wherein in the event the confidence score is lower than the threshold, the method including sending a message to the device accepting the requested change.

15. The method of claim 11, wherein in the event the confidence score is higher than the threshold, the method including sending a message to the device indicating requested change is under review.

16. The method of claim 11, the method including:
processing the sensor data to track individual subjects in the area of real space, and linking individual subjects to inventory events, and
establishing a communication link to devices associated with the individual subjects, on which to receive said messages from particular subjects and to send messages to particular subjects.

17. The method of claim 11, the method including processing the sensor data to track locations of individual subjects in the area of real space, and signal said check-out event for a particular subject if the location of the particular subject is tracked to a particular region of the area of real space.

18. The method of claim 11, the method including establishing a communication link to devices associated with the individual subjects, on which to receive messages from particular subjects interpreted as said check-out event.

19. The method of claim 11, wherein the sequences of sensor data comprise a plurality of sequences of images having overlapping fields of view.

20. The method of claim 11, wherein the log of items includes puts and takes of inventory items.

21. A non-transitory computer readable storage medium impressed with computer program instructions to automate shopping, the instructions, when executed on a processor, implement a method comprising:
receiving a sequences of sensor data of an area of real space,
processing the sequences of sensor data to identify inventory events in the area of real space linked to individual subjects, and maintain inventory events as logs of inventory events, the inventory events including an item identifier and a classification confidence score for the item,
storing sensor data from the sequences of sensor data from which the inventory events are identified;
maintaining logs of items for individual subjects, and in response to a check-out event for a particular subject, generating a digital receipt and transmit the digital receipt to a device associated with a particular subject, the digital receipt including list of items based on the items in the log of items for the particular subject with links to graphical constructs for display on the device prompting input to request changes in the list of items; and
responding to messages from the device for the particular subject requesting a change in the list of items by accessing an entry in the log of inventory events for the particular subject corresponding to the requested change,
comparing the classification confidence score in entry with a confidence threshold, and in the event the confidence score is lower than the threshold, accepting the change and updating the digital receipt, and in the event the confidence score is higher than the threshold, identifying the inventory event corresponding to the change and retrieving a set of sensor data from the stored sequences of sensor data for corroboration of the identified inventory event.

22. The non-transitory computer readable storage medium of claim 21, implementing the method further comprising, sending the set of sensor data or a link to the set of sensor data to a monitor device for review by human operator.

23. The non-transitory computer readable storage medium of claim 21, implementing the method further comprising, sending a message to the device acknowledging the requested change.

24. The non-transitory computer readable storage medium of claim 21, wherein in the event the confidence score is lower than the threshold, the method including sending a message to the device accepting the requested change.

25. The non-transitory computer readable storage medium of claim 21, wherein in the event the confidence score is higher than the threshold, the method including sending a message to the device indicating requested change is under review.

26. The non-transitory computer readable storage medium of claim 21, implementing the method further comprising:
processing the sensor data to track individual subjects in the area of real space, and linking individual subjects to inventory events, and
establishing a communication link to devices associated with the individual subjects, on which to receive said messages from particular subjects and to send messages to particular subjects.

27. The non-transitory computer readable storage medium of claim 21, implementing the method further comprising, processing the sensor data to track locations of individual subjects in the area of real space, and signal said check-out event for a particular subject if the location of the particular subject is tracked to a particular region of the area of real space.

28. The non-transitory computer readable storage medium of claim 21, implementing the method further comprising, establishing a communication link to devices associated with the individual subjects, on which to receive messages from particular subjects interpreted as said check-out event.

29. The non-transitory computer readable storage medium of claim 21, wherein the sequences of sensor data comprise a plurality of sequences of images having overlapping fields of view.

30. The non-transitory computer readable storage medium of claim 21, wherein the log of items includes puts and takes of inventory items.
